(19) United States
(12) Patent Application Publication
(10) Pub. No.: US 2009/0046186 A1
(43) Pub. Date: Feb. 19, 2009

(54) Solid state image capturing device and electronic information device

(75) Inventor: Kenichi Nagai, Hiroshima (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/221,315

(22) Filed: Aug. 1, 2008

(30) Foreign Application Priority Data
Aug. 2, 2007 (JP) 2007-202394

(51) Int. Cl. H04N 5/335

(52) U.S. Cl. 348/301; 348/E05.091

(57) ABSTRACT

A solid-state image capturing device having a two pixel sharing structure is provided. A reset section for resetting electric potential of the floating diffusion to a predetermined electric potential and a signal amplifying section for amplifying a signal in accordance with voltage of the floating diffusion to read out the signal are separately arranged. An active region of the reset section is configured to function as an active region of the floating diffusion. A wiring extending from the floating diffusion to a control electrode of the signal amplifying section is formed to be a first layer of a metal wiring having a layout of a straight line with a shortest length. Centers of the light receiving sections are oriented to centers of pixels and the centers of the pixels are arranged at regular optical intervals.

This Nonprovisional Application claims priority under 35 U.S.C. §119(a) on Patent Application No. 2007-202394 filed in Japan on Aug. 2, 2008, the entire contents of which are hereby incorporated by reference.

### BACKGROUND OF THE INVENTION

1. Field of the Invention

The present invention relates to a solid-state image capturing device having a multiple pixel sharing structure formed of semiconductor devices for performing photoelectric conversion on image light from a subject to capture an image of the subject; and an electronic information device, such as a digital camera (e.g., digital video camera and digital still camera), an image input camera, a scanner, a facsimile machine and a camera-equipped cell phone device, having the solid-state image capturing device having a multiple pixel sharing structure as an image input device in an image capturing section of the electronic information device.

2. Description of the Related Art

A MOS image sensor using a MOS (Metal Oxide Semiconductor) transistor is widely used as a conventional solid-state image capturing device described above. The MOS image sensor does not necessitate a high driving voltage unlike a CCD (Charge Coupled Device) image sensor, and the MOS image sensor has an advantage for its miniaturization because it can be integrated with peripheral circuits.

The MOS image sensor includes a signal readout circuit having an amplifying circuit and the like so as to match each of photodiodes functioning as a plurality of light receiving sections for performing photoelectric conversion on a subject light. A MOS image sensor having a multiple pixel sharing structure, in which a plurality of light receiving sections share a signal readout circuit so as to reduce the total number of transistors in an image capturing area, is known in order to reduce the area for the signal readout circuit and further extend an area in a pixel section occupied by the light receiving sections. Of the multiple pixel sharing structure, a conventional MOS image sensor having a four pixel sharing structure will be described in detail with reference to FIGS. 9 to 13.

FIG. 9 is a plan view schematically showing an exemplary pixel structure of a conventional MOS image sensor disclosed in Reference 1.

In FIG. 9, a pixel section 130 of the conventional MOS image sensor includes a plurality of light receiving sections 131 arranged in row and column directions in a matrix. The light receiving sections 131 performs photoelectric conversion on a subject light, and a transfer transistor 132 transfers the converted charge to a floating diffusion FD functioning as a voltage conversion section for performing voltage conversion on the converted charge. The converted voltage is then amplified by an amplifying transistor in a transistor region 133 in accordance with this converted voltage and is outputted to a signal line as an image capturing pixel signal for each pixel. In such a case, a signal charge is readout from each light receiving section 131 to each floating diffusion FD in each line of the plurality of light receiving sections 131 arranged in a row direction.

Two pixels (light receiving sections 131) in a diagonal direction are connected by a floating diffusion FD, and two floating diffusions FD at the top and bottom are connected by a wiring 134 in a column direction (longitudinal direction). As a result, a four pixel sharing structure, in which four pixels (light receiving sections 131) share the transistor region 133, is formed. In FIG. 9, a sharing unit of the four pixel sharing structure is surrounded by a dotted line.

FIG. 10 is a circuit diagram of a unit pixel section of a conventional MOS image sensor disclosed in Reference 2.

In FIG. 10, one signal readout circuit 105 is provided, which is shared by four photodiodes 101-104, in a conventional MOS image sensor. The readout circuit 105 includes an amplifying transistor 105a, selection transistor 105b and a reset transistor 105c. Each signal charge from the four photodiodes 101-104 is successively transferred to each floating diffusion FD in each row of pixels and conversion from charge to voltage is performed on the signal charge. The signal charge is then amplified by the amplifying transistor 105a in a pixel selected by the selection transistor 105b in accordance with signal voltage of the floating diffusion FD, and the signal charge is successively read out by a signal wire 106 as an image capturing pixel signal from each pixel. Subsequently, electric potential of the floating diffusion FD is reset to a predetermined electric potential of power supply voltage Vdd and the like by the reset transistor 105c. This is successively repeated for each row of pixels in a display screen to successively read out an image capturing pixel signal from each pixel associated with a signal charge from four photodiodes 101-104.

The photodiodes 101-104 photoelectrically convert incident light into a signal charge that has the amount of electric charge corresponding to the amount of light. Transfer gates 111-114 are provided between the photodiodes 101-104 and the floating diffusion FD.

Regarding each of the transfer gates 111-114, a transfer signal is supplied to the transfer gate 111 through an electric charge transfer control line, and a signal charge that is photoelectrically converted by the photodiode 101 is transferred to the floating diffusion FD.

A gate of the amplifying transistor 105a is connected to the floating diffusion FD by a metal wiring, and the selection transistor 105b and the amplifying transistor 105a are connected in series in between a power supply line 107 and the signal line 106. The amplifying transistor 105a has an amplifier structure of a source follower type. In addition, the power supply line 107 is connected to the floating diffusion FD through the reset transistor 105c, and the electric potential of the floating diffusion FD is periodically reset to a predetermined electric potential of the power supply voltage Vdd and the like prior to reading out of a signal charge.

FIG. 11 is a layout showing up to and including a layer of a gate electrode in a pixel section of a conventional MOS image sensor.

In FIG. 11, of a plurality of photodiodes formed in two dimensional matrix in an image capturing region, four photodiodes 101-104 arranged in a longitudinal direction share one signal readout circuit 105. The four photodiodes 101-104 do not exist in the same column, and two adjacent photodiodes 101 and 102 in a diagonal direction are respectively arranged in different columns. The two adjacent photodiodes 103 and 104 in a diagonal direction are also respectively arranged in different columns.

A floating diffusion FD1 is arranged between the photodiode 101 and the adjacent photodiode 102 in a diagonal direction. A transfer gate 111 is arranged between the floating diffusion FD1 and the photodiode 101. A transfer gate 112 is arranged between the floating diffusion FD1 and the photodiode 102.

Similarly, a floating diffusion FD2 is arranged between adjacent photodiodes 103 and 104 in a diagonal direction from an upper right to a lower left. A transfer gate 113 is arranged between the floating diffusion FD2 and the photodiode 103. A transfer gate 114 is arranged between the floating diffusion FD2 and the photodiode 104.

In short, the floating diffusion FD in FIG. 10 includes the floating diffusion FD1 shared by the photodiodes 101 and 102, and the floating diffusion FD2 shared by the photodiodes 103 and 104. The floating diffusion FD1 and the floating diffusion FD2 are connected by a metal wire in a following step.

A signal readout circuit 105 is arranged in a region between two photodiodes, such as a region between the photodiodes in the second row and the third row in FIG. 11.

The amplifying transistor 105a, the selection transistor 105b and the reset transistor 105c, which constitute the signal readout circuit 105, are arranged in one line from left to right, and they share one active region R. The drain of the reset transistor 105c and the drain of the selection transistor 105b are the same, and the source of the selection transistor 105b and the drain of the amplifying transistor 105a are the same, as well.

A first metal wiring M1 is arranged on an upper layer of the layout in FIG. 11 through a first contact C1. FIG. 12 shows this structure.

FIG. 12 is a layout showing up to and including a layer of the first metal wiring M1 in the pixel section of the conventional MOS image sensor in FIG. 10.

In FIG. 12, a signal line 106 is formed by the first metal wiring M1. The signal line 106 is arranged in a column direction (longitudinal direction) between the upper right photodiode 101 and the lower left photodiode 102 as well as the upper right photodiode 103 and the lower left photodiode 104. The signal line 106 is windingly provided in a manner to avoid the first contact C1 that is connected to the floating diffusions FD1 and FD2. The signal line 106 is connected to the source of the amplifying transistor 105a through the first contact C1.

The two floating diffusions FD1 and FD2 arranged top and bottom, the source of the reset transistor 105c and the gate of the amplifying transistor 105a are connected to an FD wiring 108 in a column direction (longitudinal direction) by each first contact C1, the FD wiring 108 being a first metal wiring M1. The floating diffusion FD1 at the upper right side and the source of the reset transistor 105c on the lower left side are located diagonally from the photodiode 102 with the photodiode 102 being at the center. Therefore, the first metal wiring M1 that connects these is arranged overlapping the photodiode 102. In such a case, light enters from the opposite side from the wiring layer, and therefore, the first metal wiring M1 may be arranged transversely overlapping the photodiode 102.

On the transfer gates 111-114, each gate of the selection transistor 105b and the reset transistor 105c and the drain of the selection transistor 105b, the first metal wirings M1 are formed through the first contact C1. The first metal wirings M1 are formed as intermediate connecting layers so as to make a contact with a second metal wiring M2, which is in a further upper layer.

The second metal wiring M2 is arranged through a second contact C2 in the upper layer of the layout shown in FIG. 12. This is shown in FIG. 13.

FIG. 13 is a layout including a layer of the second metal wiring M2 in the pixel section of the conventional MOS image sensor in FIG. 10.

In FIG. 13, a power supply line 107 and charge transfer control lines 121-124 for selecting a pixel are formed by the second metal wiring M2. The power supply line 107 is arranged in a row direction (transverse direction) on signal readout circuits 105 between rows of photodiodes. The power supply line 107 is connected to a drain of the selection transistor 105b and the reset transistor 105c (common drain between the selection transistor 105b and the reset transistor 105c) through the second contact C2.

The charge transfer control lines 121 and 122 are arranged in a row direction between the rows of the photodiodes 101 and 102. The charge transfer control line 121 is connected to the transfer gate 111 through the second contact C2. The charge transfer control line 122 is connected to the transfer gate 112 through another second contact C2.

Further, the charge transfer control lines 123 and 124 are arranged in a row direction between the rows of the photodiodes 103 and 104. The charge transfer control line 123 is connected to the transfer gate 113 through the second contact C2. The charge transfer control line 124 is connected to the transfer gate 114 through another second contact C2.

Although two lines of the second wiring M2 adjacent to top and bottom of the power supply line 107 are arranged in a row direction (transverse direction) between the rows of the photodiodes, one of the second metal wiring M2 on the upper side is connected through the second contact C2 to the gates of a plurality of reset transistors 105c, to which the second metal wiring M2 is adjacent. The other second metal wiring M2 on the lower side is connected to through the second contact C2 to the gates of a plurality of the selection transistors 105b, to which the second metal wiring M2 is adjacent.

As described above, the conventional solid-state image capturing device having the four pixel sharing structure described above secures a sufficient photodiode region even after miniaturizing of the pixel region, and makes it possible to arrange the centers of pixels at regular optical intervals.

Reference 1: Japanese Laid-Open Publication No. 2006-54276

Reference 2: Japanese Laid-Open Publication No. 2007-115994

### SUMMARY OF THE INVENTION

The conventional solid-state image capturing device having a four pixel sharing structure described above has the following problems. The floating diffusion FD active region area becomes larger by four pixels in a plan view and FD capacity C_{FD} increases. Further, the length of the metal wiring (the length of the FD wiring 108 in Reference 2) connecting the floating diffusion FD, the diffusing region of the reset transistor, and the gate of the source follower (SF) transistor (amplifying transistor) becomes longer by connecting two floating diffusions FD that are two pixels apart. As a result, a parasitic capacity, which the FD metal wiring has between other wirings and layers, increases. The FD capacity C_{FD} of the floating diffusion FD and the wiring parasitic capacity (wiring capacity) Cd, which the FD metal wiring connected to the floating diffusion FD has, have an influence on conversion gain η from charge to voltage. According to a voltage conversion equation, conversion gain η=q/(C_{FD}+Cd), which indicates into what voltage one electron is converted, the greater the FD capacity C_{FD} and the parasitic capacity Cd become, the smaller the conversion gain η of the charge voltage in the floating diffusion FD becomes, causing the sensitivity to decrease. In short, even if a signal charge is transferred from the photodiode to the floating diffusion FD and the floating diffusion takes in the signal charge, the voltage subject to conversion from charge to voltage cannot be amplified efficiently to be output to the signal line. As a result, the sensitivity of the solid-state image capturing device decreases, as well.

The present invention is intended to solve the conventional problems described above. The objective of the present invention is to provide a solid-state image capturing device having a multiple pixel sharing structure, where more photodiode area can be secured even if a pixel area that includes the photodiode area and a transistor arrangement area is miniaturized, the FD capacity is improved to provide higher sensitivity and higher resolution, and a shading due to oblique incident light does not occur; and an electronic information device using the solid-state image capturing device as an image input device in an image capturing section.

A solid-state image capturing device according to the present invention has a two pixel sharing structure, in which every two light receiving sections share a signal readout circuit among a plurality of light receiving sections for performing photoelectric conversion on image light from a subject to capture an image of the subject, and a signal charge is read out from the two light receiving sections to a shared floating diffusion to convert the signal charge into voltage and a signal is read out by the signal readout circuit in accordance with the converted voltage, in which a reset section for resetting electric potential of the floating diffusion to a predetermined electric potential and a signal amplifying section for amplifying a signal in accordance with voltage of the floating diffusion to read out the signal are separately arranged, the reset section and signal amplifying section constituting the signal readout circuit; in which an active region of the reset section is configured to function as an active region of the floating diffusion; in which a wiring extending from the floating diffusion to a control electrode of the signal amplifying section is formed to be a first layer of a metal wiring having a layout of a straight line with a shortest length; and in which centers of the light receiving sections are oriented to centers of pixels and the centers of the pixels are arranged at regular optical intervals, thereby achieving the objective described above.

A solid-state image capturing device according to the present invention has a two pixel sharing structure, in which every two light receiving sections share a signal readout circuit among a plurality of light receiving sections for performing photoelectric conversion on image light from a subject to capture an image of the subject, and a signal charge is read out from the two light receiving sections to a shared floating diffusion to convert the signal charge into voltage and a signal is read out by the signal readout circuit in accordance with the converted voltage, in which a reset section for resetting electric potential of the floating diffusion to a predetermined electric potential and a signal amplifying section for amplifying a signal in accordance with voltage of the floating diffusion to read out the signal are separately arranged, the reset section and signal amplifying section constituting the signal readout circuit; in which one side of an active region of the reset section is configured to function as an active region of the floating diffusion; in which a wiring extending from the floating diffusion to a control electrode of the signal amplifying section is formed to be a layout of a straight line with a shortest length; and in which centers of the light receiving sections are oriented to centers of pixels and the centers of the pixels are arranged at regular optical intervals, thereby achieving the objective described above.

A solid-state image capturing device according to the present invention has a two pixel sharing structure, in which every two light receiving sections share a signal readout circuit among a plurality of light receiving sections for performing photoelectric conversion on image light from a subject to capture an image of the subject, and a signal charge is read out from the two light receiving sections to a shared floating diffusion to convert the signal charge into voltage and a signal is read out by the signal readout circuit in accordance with the converted voltage, in which a wiring extending from the floating diffusion to a control electrode of the signal amplifying section is formed to be a first layer of a metal wiring; and in which centers of the light receiving sections are oriented to centers of pixels and the centers of the pixels are arranged at regular optical intervals, thereby achieving the objective described above.

A solid-state image capturing device according to the present invention is provided, in which every two light receiving sections share a signal readout circuit among a plurality of light receiving sections for performing photoelectric conversion on image light from a subject to capture an image of the subject in order to reduce a floating diffusion capacity, and a signal charge is read out from the two light receiving sections to a shared floating diffusion to convert the signal charge into voltage and a signal is read out by the signal readout circuit in accordance with the converted voltage, in which centers of the light receiving sections are oriented to centers of pixels and the centers of the pixels are arranged at regular optical intervals, thereby achieving the objective described above.

Preferably, in a solid-state image capturing device according to the present invention, the floating diffusion is provided at either end portion side of a space between opposing edges of the two light receiving sections.

Still preferably, in a solid-state image capturing device according to the present invention, an electric charge transfer section is provided between the floating diffusion and the two light receiving sections and a control electrode of the electric charge transfer section is formed in a substantially triangular shape in a plan view covering one of four corner portions of the light receiving sections having a rectangular or square shape in a plan view.

Still preferably, in a solid-state image capturing device according to the present invention, the control electrode of the electric charge transfer section and the reset section are provided in one direction along a belt shape longitudinal direction having a width of a space between the two light receiving sections in order to narrow the space.

Still preferably, in a solid-state image capturing device according to the present invention, the floating diffusion is provided in between opposing corner portions of the two light receiving sections having a rectangular or square shape in a plan view, an electric charge transfer section is provided in between the floating diffusion and the two light receiving sections, and an active region of the electric charge transfer section is provided to function as an active region of the floating diffusion.

Still preferably, in a solid-state image capturing device according to the present invention, among the plurality of light receiving sections provided in a matrix in longitudinal and transverse directions, the two light receiving sections are provided adjacent to each other in a column direction in a plan view to form a unit pixel section.

Still preferably, in a solid-state image capturing device according to the present invention, a signal amplifying section configuring the signal readout circuit is provided between rows of the unit pixel sections.

Still preferably, in a solid-state image capturing device according to the present invention, the signal amplifying section is configured with an amplifying transistor, and one driving region on a signal output side of the amplifying transistor is provided in a region between a corner portion on the row side of the two light receiving sections and a corner portion of another adjacent pair of two light receiving sections in either one or the other direction in a longitudinal direction.

Still preferably, in a solid-state image capturing device according to the present invention, a gate on a signal output side of the amplifying transistor is provided in a row region including a space between a corner portion of another adjacent pair of two light receiving sections in a transverse direction to the corner portion on the row side of the two different light receiving sections, and a corner portion of still another adjacent pair of light receiving sections in either one or the other direction in a longitudinal direction.

Still preferably, in a solid-state image capturing device according to the present invention, a signal line is connected to one driving region on a signal output side of the amplifying transistor through a contact, and the signal line is arranged in a substantially straight line along a longitudinal edge of the light receiving sections having a rectangular or square shape in a plan view.

Still preferably, in a solid-state image capturing device according to the present invention, a wiring extending from the floating diffusion to the control electrode of the signal amplifying section in the signal readout circuit is connected to the gate on the signal output side of the amplifying transistor and the floating diffusion through respective contacts, and the wiring is arranged in a substantially straight line along a longitudinal edge of another adjacent pair of two light receiving sections having a rectangular or square shape in a plan view in a transverse direction to the different two light receiving sections.

Still preferably, in a solid-state image capturing device according to the present invention, the other active region of the reset section and one driving region of a pixel selection section are connected to each other by a power supply line of the first layer of the metal wiring through respective contacts, the other driving region of the pixel selection section being connected in series to the other driving region of the signal amplifying section.

Still preferably, in a solid-state image capturing device according to the present invention, the two light receiving sections are arranged in a longitudinal direction, and every row in the plurality of light receiving sections provided in longitudinal and transverse directions on a display screen is successively selected by the pixel selection section and a signal is amplified by the signal amplifying section to read out the signal.

Still preferably, in a solid-state image capturing device according to the present invention, the regular interval arrangement for the centers of the pixels includes an arrangement pitch for the centers of the pixels including the light receiving section and a transistor arrangement region, which is a part of the signal readout circuit, being equal in both a row direction and a column direction.

Still preferably, in a solid-state image capturing device according to the present invention, the active region of the floating diffusion, the active region of the electric charge transfer section and the active region of the reset section are drawn close to one another and are shared so that a floating diffusion area becomes minimum on a layout.

Still preferably, a solid-state image capturing device according to the present invention is a MOS solid-state image capturing device.

An electronic information device according to the present invention uses the solid-state image capturing device according to the present invention as an image input device in an image capturing section.

With the structure described above, the function of the present invention will be described.

According to the present invention, the centers of respective photodiodes, which function as light receiving sections, are oriented to the centers of respective pixels, and the centers of the pixel are arranged optically at regular intervals. As a result, it is possible to prevent shading due to oblique incident light.

In the state described above, a solid-state image capturing device having a two pixel sharing structure is provided. The smaller the area for the floating diffusion FD is, the smaller the FD capacity is. Further, the shorter the FD wiring connected to the floating diffusion FD is, the smaller the parasitic capacity (wiring capacity) of the FD metal wiring is and the larger the voltage conversion gain η is. As a result, the sensitivity increases, resulting in higher resolution. More specifically, the floating diffusion FD and the reset diffusing region are positioned close to each other to be shared in a two pixel sharing structure, and further, the FD wiring, in which the floating diffusion FD and control electrodes of a signal amplifying section are connected by the first metal wiring M1 in the first layer (or the second metal wiring M2 in the second layer), is set to have a shortest layout in a substantially straight line. As a result, it is possible to significantly reduce the capacity C related to the floating diffusion FD, such as FD capacity C_{FD} and wiring capacity Cd due to the FD wiring. Further, voltage conversion gain η is significantly improved, and it is possible to provide higher sensitivity and higher resolution for the solid-state image capturing device.

In addition, the active region area of the floating diffusion FD can be reduced by half with the two pixel sharing structure, the first metal wiring M1 is defined as the FD wiring from the floating diffusion FD to the control electrode of the signal amplifying section so as to reduce the wiring capacity, and the centers of the photodiodes are oriented to the centers of the pixels to arrange the centers of the pixel optically at regular intervals. Although the effect of reducing the capacity C related to the floating diffusion FD is even smaller, it is possible to significantly reduce the capacity C related to the floating diffusion FD, such as FD capacity C_{FD} in the two pixel sharing structure and wiring capacity Cd due to the FD drawn wiring, and it is possible to improve the voltage conversion gain η. As a result, it is possible to provide the solid-state image capturing device with a high sensitivity and a fine resolution. Further, the two pixel sharing structure alone has an effect to reduce the capacity C related to the floating diffusion FD.

With the structure described above, the present invention makes it possible to prevent shading due to oblique incident light by orienting the centers of the photodiodes to the centers of the pixels and arranging the centers of the pixel optically at regular intervals. In this state, the floating diffusion FD and the reset diffusing region are combined together to be shared in a two pixel sharing structure, and further, the drawn wiring between the floating diffusion FD and the gate of the amplifying transistor is connected by the first metal wiring M1 in the first layer (or the second metal wiring M2 in the second layer) to have a shortest layout. As a result, it is possible to significantly reduce the capacity C related to the floating diffusion FD, such as FD capacity C_{FD} and wiring capacity Cd due to the FD drawn wiring. Further, voltage conversion gain η is significantly improved, and it is possible to provide higher sensitivity and higher resolution for the solid-state image capturing device. In addition, the S/N can be improved.

In addition, the active region area of the floating diffusion FD can be reduced by half with the two pixel sharing structure, the first metal wiring M1 is defined as the FD wiring from the floating diffusion FD to the control electrode of the signal amplifying section so as to reduce the wiring capacity, and the centers of the photodiodes are oriented to the centers of the pixels to arrange the centers of the pixel optically at regular intervals. Although the effect of reducing the capacity C related to the floating diffusion FD is even smaller, it is possible to significantly reduce the capacity C related to the floating diffusion FD, such as FD capacity C_{FD} in the two pixel sharing structure and wiring capacity Cd due to the FD drawn wiring and it is possible to improve the voltage conversion gain η. As a result, it is possible to provide the solid-state image capturing device with a high sensitivity and a fine resolution. In addition, S/N can be improved.

These and other advantages of the present invention will become apparent to those skilled in the art upon reading and understanding the following detailed description with reference to the accompanying figures.

### BRIEF DESCRIPTION OF THE DRAWINGS

FIG. 1 is a plan view schematically showing an exemplary essential structure of a floating diffusion section in a solid-state image capturing device having a two pixel sharing structure related to Embodiment 1 of the present invention.

FIG. 2 is a circuit diagram of a unit pixel section in the solid-state image capturing device having a two pixel sharing structure in FIG. 1.

FIG. 3 is a layout showing up to and including a layer of a gate electrode in a pixel section of the solid-state image capturing device having a two pixel sharing structure in FIG. 2.

FIG. 4 is a layout showing up to and including a layer of the first metal wiring M1 in the pixel section of the solid-state image capturing device having a two pixel sharing structure in FIG. 2.

FIG. 5 is a layout including the layer of the second metal wiring M2 in the pixel section of the solid-state image capturing device having a two pixel sharing structure in FIG. 2.

FIG. 6(a) is a plan view schematically showing an example shape of a gate of the transfer transistor in FIG. 3, and FIG. 6(b) is a longitudinal cross sectional view of essential portions of the gate of the transfer transistor and the floating diffusion FD in FIG. 3, schematically showing the Fring capacity generated between the gate of the transfer transistor and the floating diffusion FD.

FIG. 7 is a layout showing up to and including a layer of the first metal wiring M1 in the pixel section of the solid-state image capturing device having a four pixel sharing structure as a reference example for comparing the capacity C related to the floating diffusion FD with that of the solid-state image capturing device having a two pixel sharing structure according to Embodiment 1 of the present invention.

FIG. 8 is a layout showing up to and including a layer of the second metal wiring M2 in the pixel section of the solid-state image capturing device having a four pixel sharing structure as a reference example for comparing the capacity C related to the floating diffusion FD with that of the solid-state image capturing device having a two pixel sharing structure according to Embodiment 1 of the present invention.

FIG. 9 is a plan view schematically showing an exemplary pixel structure of a conventional MOS image sensor disclosed in Reference 1.

FIG. 10 is circuit diagram of a unit pixel section of a conventional MOS image sensor disclosed in Reference 2.

FIG. 11 is a layout showing up to and including a layer of a gate electrode in a pixel section of a conventional MOS image sensor in FIG. 10.

FIG. 12 is a layout showing up to and including a layer of the first metal wiring M1 in the pixel section of the conventional MOS image sensor in FIG. 10.

FIG. 13 is a layout including a layer of the second metal wiring M2 in the pixel section of the conventional MOS image sensor in FIG. 10.

FIG. 14 is a column diagram schematically showing the sensitivity of the solid-state image capturing device having a two pixel sharing structure in FIG. 3 and the sensitivity of the solid-state image capturing device having a four pixel sharing structure as a reference example in FIG. 8.

FIG. 15 is a graph schematically showing the S/N ratio in the solid-state image capturing device having a two pixel sharing structure in FIG. 3 and the S/N ratio in the solid-state image capturing device having a four pixel sharing structure as the reference example in FIG. 8.

FIG. 16 is a block diagram showing an exemplary schematic structure of an electronic information device using a solid-state image capturing apparatus that includes any one of the solid-state image capturing devices according to Embodiments 1 to 3 of the present invention in an image capturing section, the electronic information device being described as Embodiment 4 of the present invention.

1 solid-state image capturing device
2, 3 transfer transistor (charge transfer section)
2a, 3a, 4a active region
4 reset transistor (reset section)
5 selection transistor (pixel selection section)
6 amplifying transistor (signal amplifying section)
7 signal line
8, 82 power supply line
9 FD wiring
10 unit pixel section (two pixel sharing structure section)
11 signal readout circuit
12, 13 photodiode (light receiving section)
21, 31, 41, 51, 61 gate (control electrode)
22, 32 electric charge transfer control line
42 reset signal
52 pixel selection line
FD floating diffusion (electric charge voltage conversion section)
C_{FD} FD capacity
Cd wiring parasitic capacity
C1 first contact
C2 second contact
Vdd power supply voltage (reset voltage)
M1 first metal wiring
M2 second metal wiring
TX1, TX2 electric charge transfer control signal
Sel pixel selection signal
RST reset signal
90 electronic information device
91 solid-state image capturing apparatus
92 memory section
93 display section
94 communication section
95 image output section

### DESCRIPTION OF THE PREFERRED EMBODIMENTS

Hereinafter, cases will be described where Embodiments 1 through 3 of the solid-state image capturing device having the two pixel sharing structure according to the present invention are applied to a MOS image sensor, and where Embodiments 1 through 3 of the solid-state image capturing device are applied to an electronic information device, such as a camera-equipped cell phone device as a product, having the solid-state image capturing device as an image input device in an image capturing section.

### Embodiment 1

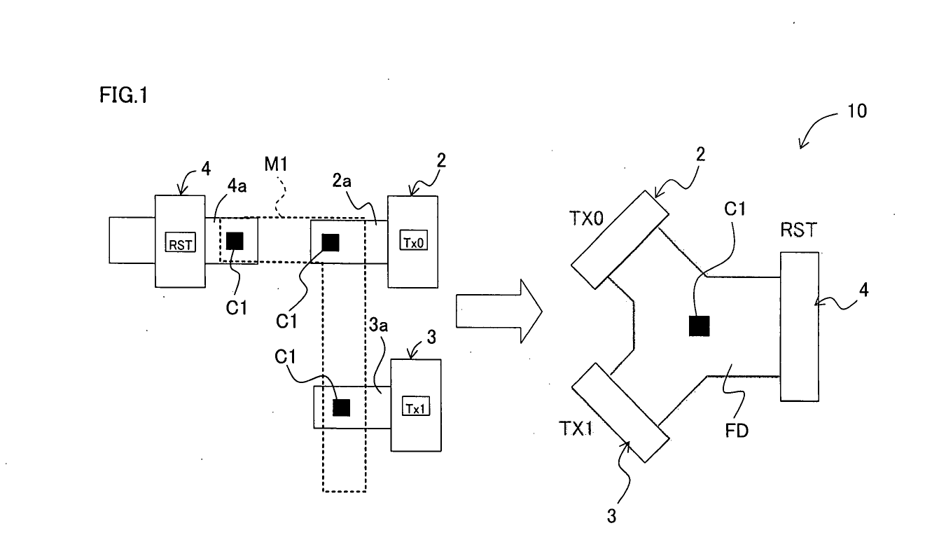

FIG. 1 is a plan view schematically showing an exemplary essential structure of a floating diffusion section in a solid-state image capturing device having a two pixel sharing structure related to Embodiment 1 of the present invention.

A conventional solid-state image capturing device having a two pixel sharing structure includes an active region 2a of a transfer transistor 2 for reading out a signal charge from a photodiode that functions as a first light receiving section, an active region 3a of a transfer transistor 3 for reading out a signal charge from a photodiode that functions as a second light receiving section, and an active region 4a of a reset transistor 4, and a floating diffusion FD is configured by connecting active region 2a to 4a with an upper layer of a first metal wiring M1 through respective contacts C1. In FIG. 1, a unit pixel section 10 in the solid-state image capturing device having a two pixel sharing structure according to Embodiment 1 does not require the conventional upper layer of the first metal wiring M1, and the active region 2a of the transfer transistor 2, the active region 3a of the transfer transistor 3 and the active region 4a of the reset transistor are arranged close to one another and combined together to form a floating diffusion FD. Thus, the upper and lower (longitudinal direction) two pixel sharing structures enable to reduce the active region area of the floating diffusion FD by half or more. In addition, the active region area of the floating diffusion FD can be even reduced by arranging the diffusion region 4a of the reset transistor 4 closer, which also serves as an active region of the floating diffusion FD. The two light receiving sections (first light receiving section and second light receiving section) that share the two pixels are arranged vertically, and signals from a row of a plurality of light receiving sections are successively read out for each row from the plurality of light receiving sections arranged in longitudinal and transverse directions on a display screen.

Conventionally, anew space is required inside the unit pixel section 10 if the reset transistor 4 is provided inside the unit pixel section 10. Therefore, the arrangement regions for respective transistors for reading out a signal are provided all together outside the unit pixel section 10. According to the solid-state image capturing device having a two pixel sharing structure of Embodiment 1, the photodiode area is sufficiently secured even if the pixel area is miniaturized, and the centers of the pixels, which include arrangement regions for the photodiode and the transistor of the signal readout circuit, are arranged in a regular optical interval from top to bottom (a column direction or a longitudinal direction) and from left to right (a row direction or a transverse direction). Therefore, inside the unit pixel section 10, intervals of rows of the upper and lower photodiodes are regularly spaced. The reset transistor 4 is arranged near the floating diffusion FD between the rows of the photodiodes, so that the active region area of the floating diffusion FD is significantly reduced. Further, although the active region of the floating diffusion FD, the active region 2a of the transfer transistor 2, the active region 3a of the transfer transistor 3, the active region 4a of the reset transistor are gathered close to one another to be shared and overlapped so that the FD area will be minimal, the concentration of the active region of the floating diffusion FD and the concentration of other active regions 2a to 4a are the same.

The centers of the pixels including the arrangement region for the photodiode and the transistor are arranged at regular optical intervals in transverse and longitudinal directions, so that the center of the photodiode (an intersection point of diagonal lines of a rectangle) is oriented to the center of the pixel (in the case of two sharing pixels, each intersection point of diagonal lines of two rectangles including two photodiodes and signal readout circuits). If the center of the pixel is shifted, the center of the microlens formed above the corresponding photodiode needs to be shifted as well. As a result, a gap is created in between microlenses, the microlens cannot be large in size and light in a larger region cannot be condensed, and the light receiving sensitivity decreases due to loss of light. Further, if the center of the pixel is shifted, the arrangement of the photodiodes, which are associated with Gb and Gr of green color in a diagonal direction, for example, and the corresponding microlenses will not be balanced. If the arrangement pitch of microlenses is ill-balanced, light condensed by the microlens that enters from a diagonal direction may not reach one photodiode and may read another photodiode. Depending on the photodiodes, condensed light from the microlens may or may not reach. However, if the centers of the pixels are at regular intervals, it does not occur that the light condensed from the microlenses may reach or may not reach depending on the photodiode. Instead, if the condensed light goes off the course, the condensed light goes off the course at all the photodiodes, and therefore, the degree of the condensed light to the photodiodes become constant and light receiving variation will be eliminated. If the centers of the pixels are shifted, light from a diagonal directions cannot be condensed well, creating a shading that leads to light receiving variation. If the centers of the pixels are arranged at regular intervals, such problems can be prevented.

In addition, although described later, the space between the rows where the reset transistors 4 are provided and the space between the rows where the selection transistors 5 and the amplifying transistors 6 are provided have the same width (same gap) in order to arrange pixel centers at regular optical intervals (the arrangement pitch of photodiodes are the same transversely and longitudinally). Herein, although the arrangement pitch for the centers of the photodiodes are the same in the transverse and longitudinal directions, the external form of the photodiode in plan view is rectangular, and the width in between transverse columns (same intervals) is narrower than the width in between longitudinal rows by the width that does not include the arrangement region of the transistor. As a result, the area for the photodiode is widened.

The arrangement for the floating diffusion FD and the reset transistor in the two pixel sharing structure according to Embodiment 1 will be further discussed.

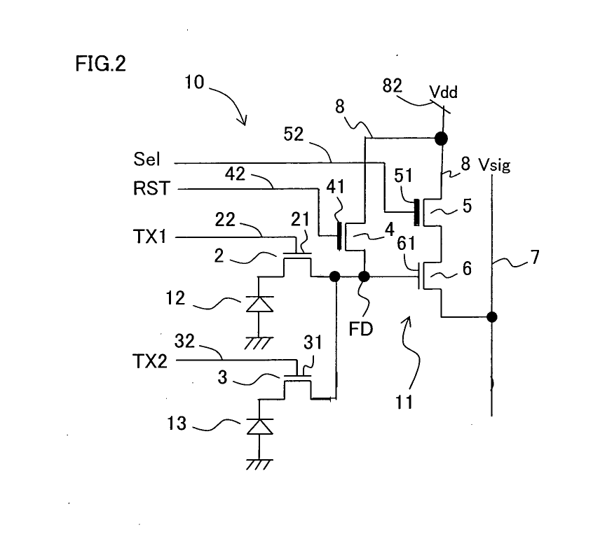

For example, a case will be considered where floating diffusions FD are arranged in a longitudinal direction at an intermediate position of an edge in a transverse direction between rows of an upper and lower pair of photodiodes, the source of the reset transistor is combined with the floating diffusion FD, and the selection transistor and the amplifying transistor, which will be described later in FIG. 2, together with an active region are provided between rows of an upper and lower pair of photodiodes.

When the floating diffusion FD and the reset transistor are provided on the left side between rows of the pair of upper and lower photodiodes, the selection transistor and the amplifying transistor need to be provided on the right side. However, they are difficult to fit in a transverse direction. If the selection transistor and the amplifying transistor are arranged in a longitudinal direction, the photodiode is partially cut for the transistors, resulting in a less area and not being rectangular. Further, if the floating diffusion FD is located at the center of each opposing edge of photodiodes in a transverse direction, a larger longitudinal width is needed in between the rows for the gate region of the transfer transistor. Compared to the case where there is only the reset transistor in between the rows, a gate region is also added, and the rows between the photodiodes become wider. Due to this, the center of the photodiode is shifted from the center of the pixel, and the arrangement pitch of the photodiode is not set to be at regular intervals. Even if the microlens is adjusted to the center of the pixel, the condensed light from the microlens does not advance to the center of the photodiode and the condensed light is off the course, resulting in shading.

Therefore, according to Embodiment 1 of the present invention, the position of the floating diffusion FD is at an end portion on either left or right of an opposing edge of the photodiode (or either end portion of the two end portions). At this point, the gate of the transfer transistor is provided in a triangle form on a corner portion of the photodiode. The gate may protrude between the rows of the photodiodes. However, the rows between the photodiodes can be narrower by proving the gate and the reset transistor side by side. In addition, the selection transistor and the amplifying transistor may be provided between the row of the unit pixel sections 10 and another row of the unit pixel sections 10 one row below. In short, the floating diffusion FD is provided for either the left end portion or the right end portion of the photodiode, and the selection transistor and the amplifying transistor are provided between the rows of the unit pixel sections 10. As a result, the center of each photodiode is oriented to the center of the corresponding pixel, and the center of the photodiode is oriented to the center of the microlens. Further, the centers of the lenses can be arranged in regular intervals, preventing the occurrence of shading.

Conventionally, the reset transistor 4, the selection transistor 5 and the amplifying transistor 6 are all together provided in one active region. However, according to Embodiment 1 of the present invention, the reset transistor 4 is separated from the selection transistor 5 and the amplifying transistor 6. Herein, a drain functioning as another active region of the reset transistor 4 and the selection transistor 5, which is connected in series to the amplifying transistor 6, are connected to each other by a power supply line 8 of the first layer of the metal wiring M1 through each contact. Although it is necessary to provide a new power supply line 8 between the separated drain of the reset transistor 4 and the drain of the selection transistor 5, the capacity related to the floating diffusion FD can be reduced as described above by providing the reset transistor 4 near the floating diffusion FD.

FIG. 2 is a circuit diagram of a unit pixel section in the solid-state image capturing device having a two pixel sharing structure in FIG. 1.

In FIG. 2, a unit pixel section 10 of a solid-state image capturing device 1 having a two pixel sharing structure includes, two photodiodes 12 and 13, two transfer transistors 2 and 3 for reading out a signal charge by responding to respective photodiodes, and one signal readout circuit 11 for both of the transfer transistors.

The read out circuit 11 has a selection transistor 5 as a pixel selection section for selecting a plurality of pixels in each line (row line) to output a signal, an amplifying transistor 6 as a signal amplifying section connected in series to the selection transistor 5 and for amplifying a signal in accordance with signal charge voltage of the floating diffusion FD of the selected pixel, and a reset transistor 4 as a reset section for resetting the electric potential of the floating diffusion FD to a predetermined electric potential after the amplifying transistor 6 outputs a signal. Signal charges from the top and bottom photodiodes 12 and 13 are successively transferred to the floating diffusion FD for each row of pixels to convert the electric charge into the voltage. The converted signal voltage is amplified by the amplifying transistor 6, whose pixel is selected by the selection transistor 5, and the signal voltage is successively read out as an image capturing signal for each pixel by a signal line 7. Subsequently, the floating diffusion FD is reset by the reset transistor 4 to a predetermined electric potential of the power supply voltage Vdd. This process is successively repeated for each line of a plurality of pixels on a display screen, and image capturing signals for each line corresponding to the signal charges from the photodiodes 12 and 13 are successively read out to the signal line 7.

The photodiodes 12 and 13 perform photoelectric conversion on incident light into a signal charge in accordance with the light amount. The transfer transistors 2 and 3 are provided between the photodiodes 12 and 13 and the floating diffusion FD respectively.

Electric charge transfer control signal TX1 and TX2 are provided for respective gates of the transfer transistors 2 and 3 through electric charge transfer control lines 22 and 32 for transferring electric charges. Signal charges on which photoelectric conversion is performed by the photodiodes 12 and 13 are successively transferred for each pixel line to the floating diffusion FD.

The floating diffusion FD is connected with the gate of the amplifying transistor 6. The selection transistor 5 and the amplifying transistor 6 are connected in series between the power supply line 8 and the signal line 7. The amplifying transistor 6 has an amplifier structure of a source follower type. In addition, the power supply line 8 is electrically connected to the floating diffusion FD through the reset transistor 4, and the electric potential of the floating diffusion FD is regularly reset to a predetermined electric potential, such as the power supply voltage Vdd, by the reset transistor 4 after the signal readout to the signal line 7 and before the signal readout to the floating diffusion FD.

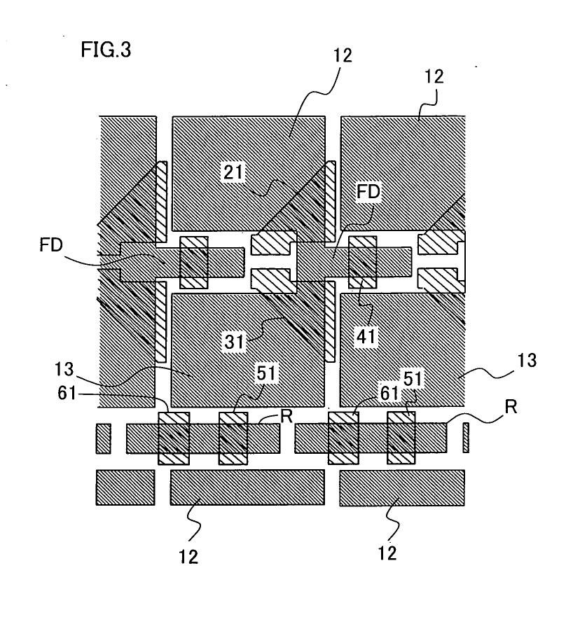

FIG. 3 is a layout showing up to and including a layer of a gate electrode in a pixel section of the solid-state image capturing device having a two pixel sharing structure in FIG. 2.

In FIG. 3, of a plurality of photodiodes formed in a two dimensional matrix in an image capturing region and having a rectangle (or square) in a plan view, two photodiodes 12 and 13 arranged in a longitudinal direction share one signal readout circuit 11. The top and bottom photodiodes 12 and 13 are arranged top and bottom adjacent to each other in the same column.

A floating diffusion FD is arranged with a predetermined width at the right end portion of a row between the photodiode 12 and the adjacent photodiode 13 below in a longitudinal direction in such a manner to connect the photodiodes 12 and 13. A gate 21 of a transfer transistor 2 is arranged at the lower right corner between the floating diffusion FD and the photodiode 12. A gate 31 of a transfer transistor 3 is arranged at the upper right corner between the floating diffusion FD and the photodiode 13.

In addition, as a unit pixel section 10 surrounded by a dotted line including the two photodiodes 12 and 13, a portion of a signal readout circuit 11 (a selection transistor 5 and an amplifying transistor 6) excluding a reset transistor 4 is arranged in a region between unit pixel sections 10, such as a region between the photodiodes 13 and 12 on the second and third rows in FIG. 2.

The selection transistor 5 (gate 51) and the amplifying transistor 6 (gate 61), which constitute the signal readout circuit 11, are arranged side by side in one line, and they share one active region R. The source of the selection transistor 5 and the drain of the amplifying transistor 6 are the same.

On the other hand, regarding the reset transistor 4 (gate 41) of the signal readout circuit 11, the reset transistor 4 is provided near the floating diffusion FD between the rows of the two photodiodes 12 and 13 as described before with reference to FIG. 1. In short, as described before, an active region 4a of the reset transistor 4 is combined together with an active region 2a of the transfer transistor 2 and an active region 3a of the transfer transistor 3 to form an active region of the floating diffusion FD. Thus, the reset transistor active region 4a and the FD active region are combined, so that the area for the FD active region can be significantly reduced. As a result, the FD capacity C_{FD} is significantly improved and the voltage conversion efficiency (conversion gain) in the floating diffusion FD is improved, thereby obtaining the solid-state image capturing device 1 having a high sensitivity and a high resolution.

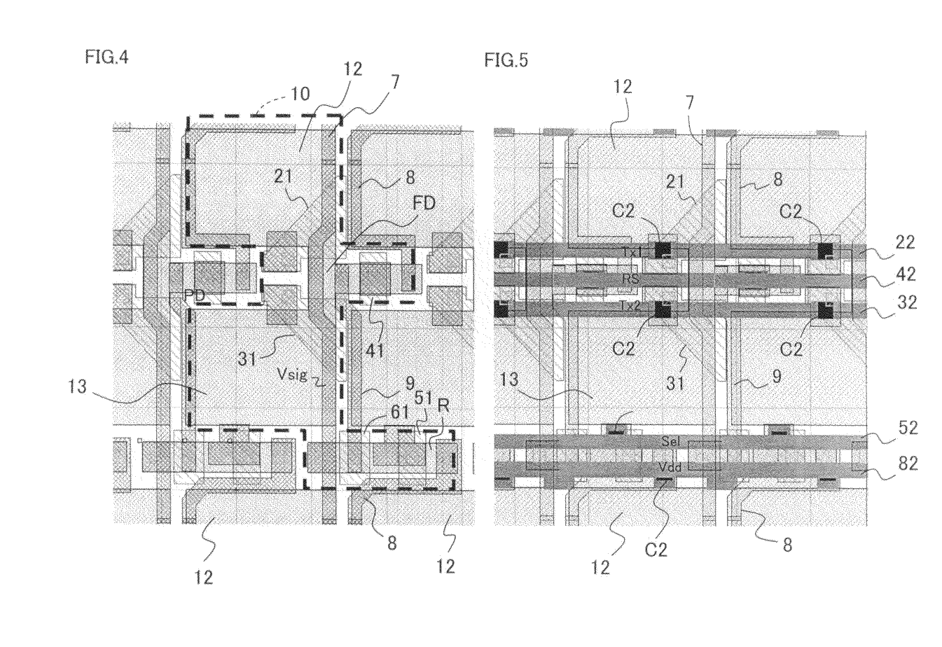

A first metal wiring M1 is arranged through a first contact C1 on an upper layer of the layout in FIG. 3. FIG. 4 shows this structure.

FIG. 4 is a layout showing up to and including a layer of the first metal wiring M1 in the pixel section of the solid-state image capturing device having a two pixel sharing structure in FIG. 2.

In FIG. 4, a signal line 7 is formed as the first metal wiring M1 with a metal such as aluminum. The signal line 7 is arranged in a column direction (longitudinal direction) in a region between a pair of the upper and lower photodiodes 12 and 13 and another transversely adjacent pair of the upper and lower photodiodes 12 and 13 (a region between transverse columns). The signal line 7 is provided windingly or curvedly to avoid contacting the first contact C1 connected to the floating diffusion FD (FD wiring 9 connected to the gate 61 of the amplifying transistor 6). The signal line 7 is connected to the source of the amplifying transistor 6 through another first contact C1.

With regard to an FD wiring 9 in a column direction, the floating diffusion FD combined with the source of the reset transistor 4 and the gate 61 of the amplifying transistor 6 are connected by the first metal wiring M1 through each first contact C1. The FD wiring 9 is arranged in a substantially straight line with the shortest length along the right side edge of the photodiode in a longitudinal direction between the gate 61 of the amplifying transistor 6 and the floating diffusion FD. Thus, the FD wiring 9 has a layout in a straight line with the shortest length equivalent to one pixel length (which is conventionally two pixel length), so that the length (area) of a metal wiring connected to the FD active region is as half as before. As a result, the wiring parasitic capacity (wiring capacity) Cd of the FD wiring 9 together with other wirings and layers is significantly improved and the voltage conversion efficiency (conversion gain) in the floating diffusion FD is improved, thereby obtaining the solid-state image capturing device 1 having even higher sensitivity and higher resolution.

In short, the gate 61 of the amplifying transistor 6 is provided adjacent to the lower left corner portion of the photodiode 13 in the adjacent side unit pixel section 10, and the source of the reset transistor 4 is provided adjacent to the upper left corner portion of the photodiode 13. As a result, the floating diffusion FD combined with the source and the gate 61 of the amplifying transistor 6 can be connected in a straight line from top to bottom by the FD wiring 9, and the FD wiring 9 will have the shortest length of one pixel length. Although the FD wiring 9 is in a straight line along the left longitudinal edge of the photodiode 13, the FD wiring 9 actually approaches to the center portion of the floating diffusion FD (to the left side in the plan view). Note that the FD wiring 9 can be in a completely straight line to reduce the wiring capacity Cd, and that the position of the gate 61 of the amplifying transistor 6 can be arranged slightly to the right.

The FD wiring 9 for connecting the floating diffusion FD and the gate 61 of the amplifying transistor 6 (amplifying transistor gate connecting wiring with the floating diffusion FD) is formed by the first metal wiring M1 in order to reduce as much wiring capacity Cd as possible. Conventionally, the FD wiring is formed by an upper layer of a second metal wiring M2. However, the parasitic capacity occurs in the intermediate layer (layer between the contact C1 and the contact C2) functioning as a connecting section between the second metal wiring M2 and the first metal wiring M1. According to Embodiment 1 of the present invention, in order to reduce the wiring capacity Cd of the FD wiring 9 as much as possible compared to the conventional case, the FD wiring 9 is formed by the lower layer of the first metal wiring M1 instead of the second metal wiring M2. With such a structure, the voltage conversion efficiency (conversion gain) is improved and the solid-state image capturing device 1 with even higher sensitivity and higher resolution is obtained.

The first metal wirings M1 are formed on the gates 21 and 31 of the respective transfer transistors 2 and 3, the gate of the reset transistor 4, the gate of the selection transistor 5 and the drain of the selection transistor 5 through respective first contacts C1. The first metal wirings M1 are intermediate layers of the afore-mentioned connection section and are formed to make a contact with the upper layer of second metal wiring M2.

The metal wiring M2 is arranged in the upper layer of the layout shown in FIG. 4 through the second contact C2. FIG. 5 shows this structure.

FIG. 5 is a layout including the layer of the second metal wiring M2 in the pixel section of the solid-state image capturing device having a two pixel sharing structure in FIG. 2.

In FIG. 5, a power supply line 82, charge transfer control lines 22 and 32, a reset signal line 42 and a pixel selection line 52 are formed by the second metal wiring M2. The power supply line 82 is arranged in a row direction (transverse direction) on a portion of the signal readout circuit 11 in a row between photodiodes 12 and 13 that form a unit pixel section 10 and photodiodes 12 and 13 that form another adjacent unit pixel section 10 below. The power supply line 82 is connected to the drain of the selection transistor 5 through the second contact C2 and is further connected to the drain of the reset transistor 4 through the power supply line 8 so as to supply power supply voltage Vdd to each drain of the reset transistor 4 and the selection transistor 5. In addition, a pixel selection line 52 is arranged in a row direction (transverse direction) parallel to the power supply line 82 on a portion of the signal readout circuit 11 in a row between the adjacent top and bottom photodiodes 13 and 12 in the unit pixel section 10. The pixel selection line 52 is connected to the gate of the selection transistor 5 through the second contact C2 to supply a pixel selection signal Sel to the gate of the selection transistor 5.

The charge transfer control lines 22 and 32 are arranged in a row direction in a row between the photodiodes 12 and 13 that constitute the unit pixel section 10. The charge transfer control section 22 is connected to the gate 21 of the transfer transistor 2 through the second contact C2 to supply the charge transfer control signal TX1 to the gate of the transfer transistor 2. In addition, the charge transfer control line 32 is connected to the gate 31 of the transfer transistor 3 through the second contact C2 to supply the charge transfer control signal TX2 to the gate of the transfer transistor 3.

The reset signal line 42 is located on the row between the photodiodes 12 and 13 that constitute the unit pixel section 10, and is arranged parallel to the charge transfer lines 22 and 32 in between them. The reset signal line 42 is connected to the gate 41 of the reset transistor 4 through the second contact C2 to supply a reset signal RST to the gate 41 of the reset transistor 4.

Herein, the output conversion gain η of the solid-state image capturing device having a two pixel sharing structure according to Embodiment 1 of the present invention and the output conversion gain η of a solid-state image capturing device having a four pixel sharing structure as a reference example are compared with each other.

The capacity C related to the floating diffusion FD, such as FD capacity C_{FD} of the floating diffusion FD and parasitic capacity (wiring capacity) Cd due to the FD metal wiring to which the floating diffusion FD is connected, has an influence on the conversion gain η from electric charge to voltage, and a voltage conversion equation, conversion gain η=q/(C_{FD}+Cd), which indicates into what voltage one electron is converted as described before, holds. As the effect of the solid-state image capturing device having a two pixel sharing structure according to Embodiment 1 of the present invention, the output conversion gain η is about 2.5 times as great as that of the solid-state image capturing device having a four pixel sharing structure as a reference example, and therefore the solid-state image capturing device having a two pixel sharing structure is significantly improved and the sensitivity and the resolution are also improved.

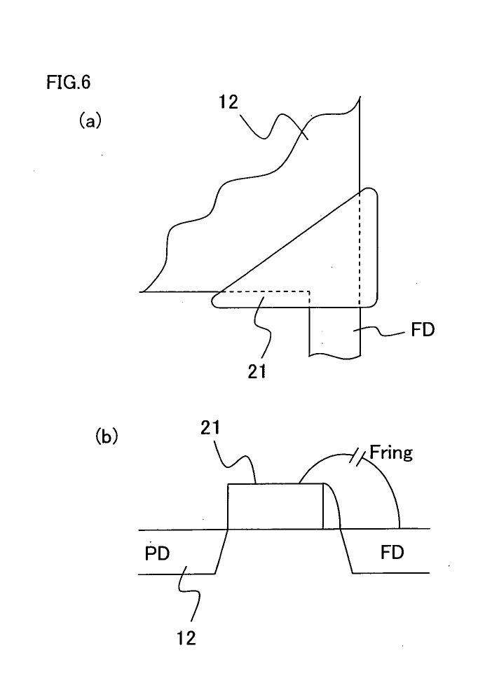

Compared with the case with the solid-state image capturing device having a four pixel sharing structure as a reference example (the FD capacity C_{FD} is defined as “1” in the case of the reference example), the FD capacity C_{FD} of the present invention, for example, which is a PN junction capacity, is 0.54. The Fring capacity is a capacity between the gate 21 of the transfer transistor 2 and the floating diffusion FD as shown in FIG. 6, for example, which is a capacity determined by the width between the gate 21 and the floating diffusion FD (if it is a two pixel sharing case, the capacity is about half of the capacity value of the four pixel sharing case). The Fring capacity is 0.41. The wiring capacity Cd, which is a parasitic capacity of the FD wiring 9 described above, is 0.25. The SF gate capacity, which is a capacity of the gate 61 of the amplifying transistor 6, is 1.0. The conversion gain η of the solid-state image capturing device 1 having a two pixel sharing structure (μV/e) is about 2.5 times as great as the solid-state image capturing device having a four pixel sharing structure as a reference example.

Herein, the S/N ratio, which affects the sensitivity and the picture quality, is examined as an effect of Embodiment 1.

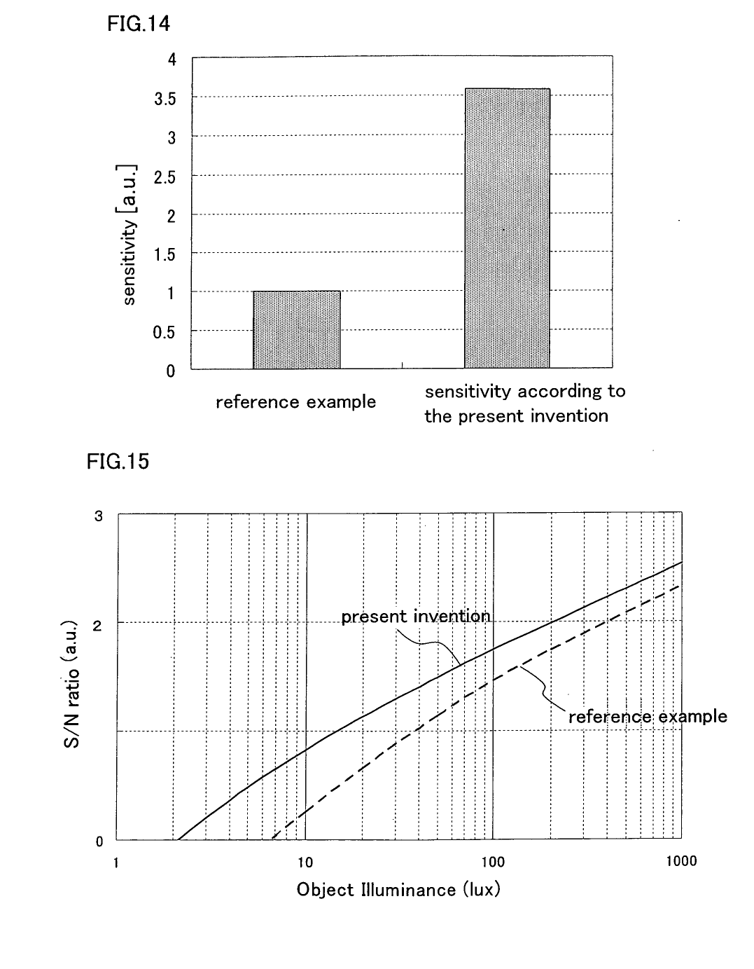

FIG. 14 is a diagram schematically showing the sensitivity of the solid-state image capturing device having a two pixel sharing structure in FIG. 3 and the sensitivity of the solid-state image capturing device having a four pixel sharing structure as the reference example described above by using a bar chart.

As shown in FIG. 14, a unit of sensitivity is mV/(Lux·sec) while the unit of the conversion gain η described above is μV/e. The sensitivity, mV/(Lux·sec), greatly changes due to not only the conversion gain η of the electric charge voltage in the floating diffusion FD connected to the gate 61 of the amplifying transistor 6, but also how much light is condensed in the light receiving section. Compared the sensitivity of the solid-state image capturing device having a two pixel sharing structure in FIG. 3 with the sensitivity of the solid-state image capturing device having a four pixel sharing structure as a reference example, the sensitivity of the layout having a two pixel sharing structure according to Embodiment 1 of the present invention exceeds the sensitivity of the layout having a four pixel sharing structure by 3.5 times. This is a result of the layout according to Embodiment 1 of the present invention, where the wiring width is narrowed, the wire arrangement is avoided above the light receiving section, and the metal wiring is shortened, the result being greatly influenced by the improvement on the conversion gain η (μV/e) as well as the improvement on the opening ratio for the light receiving section.

FIG. 15 is a diagram schematically showing the S/N ratio in the solid-state image capturing device having a two pixel sharing structure in FIG. 3 and the S/N ratio in the solid-state image capturing device having a four pixel sharing structure as the reference example described above by using a graph.

In short, what is important for a solid-state image capturing device is the degree of S/N ratio (magnitude of a signal per unit noise) at the time of low luminous intensity. Taking 10 (Lux) of low luminous intensity as an example as shown in FIG. 15, the S/N ratio in that case is about 0.8 in the layout having a two pixel sharing structure according to Embodiment 1 of the present invention while the S/N ratio is about 0.3 in the layout having a four pixel sharing structure as a reference example. The layout having a two pixel sharing structure according to Embodiment 1 exceeds the layout having a four pixel sharing structure by 2.5 times. The S/N ratio affects a picture quality of a display screen, and the conversion gain η (μV/e) from the electric charge to voltage and the sensitivity (mV/(Lux·sec)) of the solid-state image capturing device according to Embodiment 1 are significantly improved, resulting in a significant improvement in the S/N ratio.

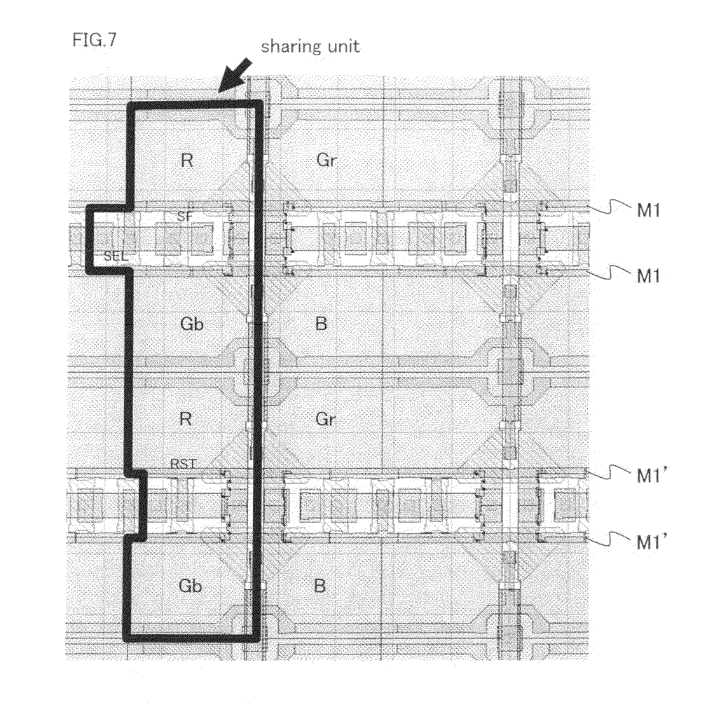

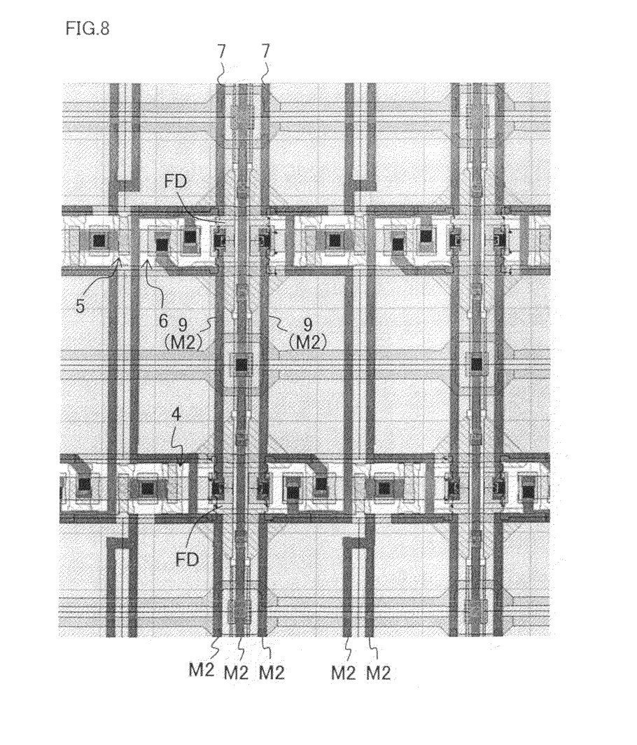

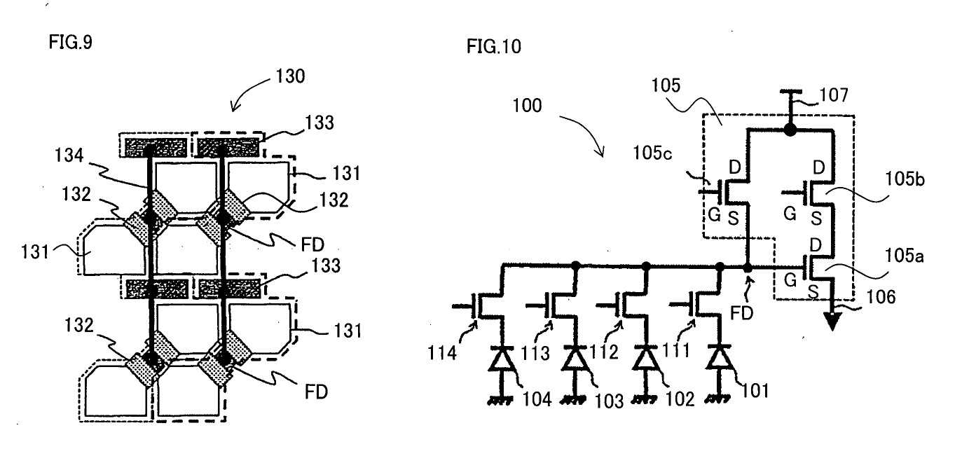

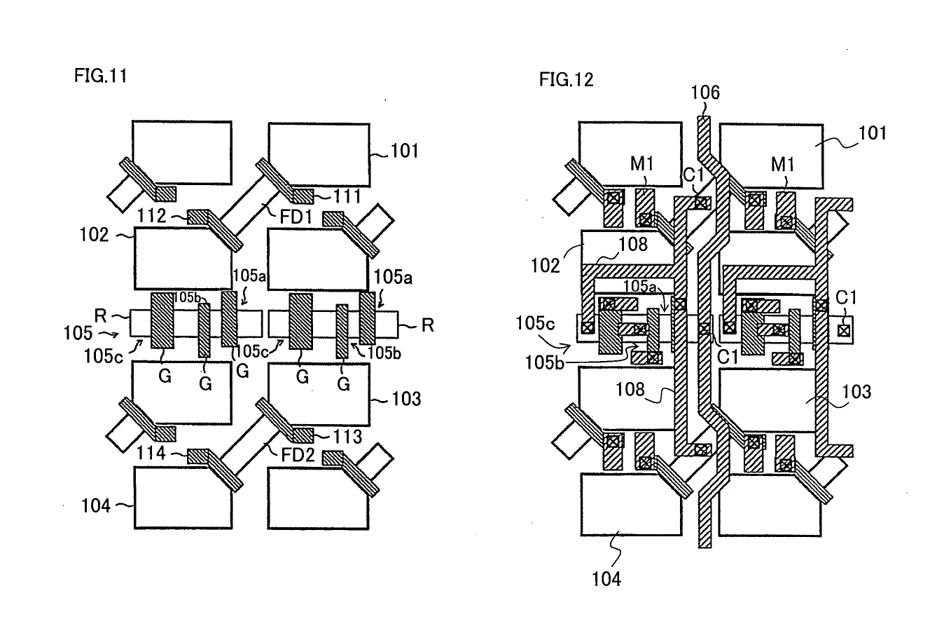

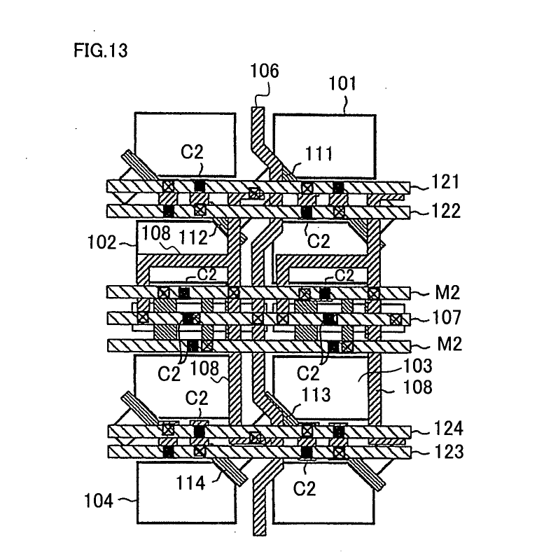

The layout of the solid-state image capturing device having a four pixel sharing structure as a reference example will be briefly described with reference to FIGS. 7 and 8.

FIG. 7 is a layout showing up to and including a layer of the first metal wiring M1 in the pixel section of the solid-state image capturing device having a four pixel sharing structure as a reference example described above for comparing the capacity C regarding the floating diffusion FD with that of the solid-state image capturing device having a two pixel sharing structure according to Embodiment 1 of the present invention.

In FIG. 7, a four pixel sharing structure is shown, the four pixel sharing structure including, four light receiving sections adjacent to each other in a longitudinal direction, such as a photodiode (R), a photodiode (Gb), a photodiode (R) and a photodiode (Gb) sharing one signal readout circuit. Of a selection transistor (Sel), an amplifying transistor (SF), and a reset transistor (RST) that constitute a signal readout circuit, the selection transistor (Sel) and the amplifying transistor (SF) are separated from the reset transistor (RST) longitudinally. The selection transistor (Sel) and the amplifying transistor (SF) are provided in a row between the two upper photodiode (R) and photodiode (Gb). In addition, the reset transistor (RST) is provided in a row between the two lower photodiode (R) and photodiode (Gb). The first metal wiring M1 provided in a row between the two upper photodiodes is connected through a contact to the gate of the selection transistor (Sel) that constitutes the signal readout circuit. In addition, the first metal wiring M1′ provided in a row between the two lower photodiodes is connected through a contact to the gate of the reset transistor (RST) that constitutes the signal readout circuit.

FIG. 8 is a layout showing up to and including a layer of the second metal wiring M2 in the pixel section of the solid-state image capturing device having a four pixel sharing structure as a reference example described above for comparing the capacity C regarding the floating diffusion FD with that of the solid-state image capturing device having a two pixel sharing structure according to Embodiment 1 of the present invention.

In FIG. 8, a signal line 7 is connected through a contact to an output side driving region of the amplifying transistor in a longitudinal column between four photodiodes having a four pixel sharing structure and four photodiodes having a four pixel sharing structure adjacent in a transverse direction. The signal line 7 is provided as the second metal wiring M2 above the first metal wiring M1. In addition, as the second metal wiring M2, the FD wiring 9 connects the floating diffusion FD between the two upper photodiodes and the floating diffusion FD between the two lower photodiodes through respective contacts, and the FD wiring 9 also connects, other than the floating diffusions FD, the gate of the amplifying transistor (SF) through another contact.

As described above, according to the solid-state image capturing device 1 having a two pixel sharing structure according to Embodiment 1 of the present invention, two photodiodes 12 and 13, which perform photoelectric conversion on an image light from a subject to capture the image of the subject, share one signal readout circuit 11. A signal charge is read out from the two photodiodes 12 and 13 to the common floating diffusion FD and the signal charge is converted into voltage. In accordance with the conversion voltage, the signal readout is performed by the signal readout circuit 11. The reset transistor 4 for resetting the electric potential of the floating diffusion FD and the amplifying transistor 6 for amplifying a signal in accordance with the voltage of the floating diffusion FD to read out the signal, both of which constitute the signal readout circuit 11, are arranged separately. The source of the reset transistor 4, which is an active region, is formed as the active region of the floating diffusion FD, as well. The FD wiring 9 extending from the floating diffusion FD to the gate functioning as a control electrode of the amplifying transistor 6 has a layout in a straight line with the shortest length as the first layer of the metal wiring M1 through respective contacts. Further, the centers of the photodiodes are oriented to the centers of the pixels to arrange the centers of the pixels at regular optical intervals.

According to Embodiment 1 described above, the centers of the photodiodes are oriented to the centers of the pixels and the centers of the pixels are arranged at regular optical intervals, so that shading due to incident light in a diagonal direction can be prevented. In such a state, the floating diffusion FD and the reset diffusing region are in series only with the two pixel sharing structure. Further, the first layer metal wiring forms a straight and shortest layout of a drawn wiring (FD wiring 9) between the floating diffusion FD and the gate 61 of the amplifying transistor 6. As a result, it is possible to significantly reduce the capacity C regarding the floating diffusion FD, such as FD capacity C_{FD} and wiring capacity Cd due to the FD wiring 9. Further, voltage conversion gain η is significantly improved, and it is possible to provide higher sensitivity and higher resolution for the solid-state image capturing device.

Further, noise is carried by the power supply voltage Vdd of the power supply line 82 from the outside power source, and it will be a problem if the noise is carried by the floating diffusion FD and is amplified to be output as a signal. However, the FD wiring 9 has a layout of a substantially straight line with the shortest length as described before, and the FD wiring 9 functions as the first metal wiring M1. As a result, the FD wiring 9 becomes distant from the power supply line 82 of the second metal wiring M2, and the noise affecting through the capacity in the wiring is reduced.

Further, other than a reduction effect of the capacity C regarding the floating diffusion FD, the two pixel sharing structure makes it possible to interpolate a specific pixel with an average value of nearby four pixels of the same color if the specific pixel is damaged when performing a color interpolating processing at the time of pixel damage. However, the four pixel sharing structure in a longitudinal direction includes the same color as shown in FIG. 7, and the pixels of the same color used for the color interpolating processing near the specific pixel cannot be read out due to the damaged transistor in the signal readout circuit shared by the four pixels. On the other hand, with the two pixel sharing structure that does not include the same color, nearby pixels used for the color interpolating processing of the damaged color are not damaged, and therefore, color interpolating can be performed with a regular color interpolating processing, and a pixel defect can be repaired.

Further, the form of the gate 21 of the transfer transistor 2 is a triangle in a plan view. Although the electric charge readout distances are different in its inner circumference side and its outer circumference side, a channel is widened and turned away from the short distant internal circumference side and a signal charge is read out in order to extend the channel length of the transfer transistor. With this structure, the plan view area of the floating diffusion FD can be narrowed more compared with the case where the form of the gate 21 of the transfer transistor 2 is a shape of a belt. As a result, the FD capacity can be even smaller.

### Embodiment 2

According to Embodiment 1 described above, the active region area of the floating diffusion FD is reduced by half with the two pixel sharing structure, and the FD active region area is reduced by the reset transistor active region functioning as the active region of the floating diffusion FD. Further, in order to reduce the wiring capacity connected to the floating diffusion FD, the FD wiring 9, which extends from the floating diffusion FD to the gate of the amplifying transistor, is defined as the first metal wiring M1 instead of the second metal wiring M2. Further, the FD wiring has a layout in a substantially straight line with the shortest length. The centers of the photodiodes are oriented to the centers of the pixels to arrange the centers of the pixels in regular optical intervals. In Embodiment 2 of the present invention, the condition where the FD wiring 9, which extends from the floating diffusion FD to the gate of the amplifying transistor, is defined as the first metal wiring M1 instead of the second metal wiring M2 in order to reduce the wiring capacity, is excluded from all the conditions in Embodiment 1. That is, a case where the FD wiring 9 is configured with the second metal wiring M2 will be described.

According to the solid-state image capturing device having a two pixel sharing structure according to Embodiment 2 of the present invention, two photodiodes 12 and 13, which perform photoelectric conversion on an image light from a subject to capture the image of the subject, share one signal readout circuit 11. A signal charge is read out from the two photodiodes 12 and 13 to the common floating diffusion FD and the signal charge is converted into voltage. In accordance with the conversion voltage, the signal readout is performed by the signal readout circuit 11. The reset transistor 4 for resetting the electric potential of the floating diffusion FD and the amplifying transistor 6 for amplifying a signal in accordance with the voltage of the floating diffusion FD to read out the signal, both of which constitute the signal readout circuit 11, are arranged separately. The source of the reset transistor 4, which is an active region, is formed as the active region of the floating diffusion FD, as well. The FD wiring 9 extending from the floating diffusion FD to the gate functioning as a control electrode of the amplifying transistor 6 has a layout in a straight line with the shortest length (for example, in the case of four pixel sharing in FIG. 8) as the second layer of the metal wiring M2 through respective contacts and the first layer of the metal wiring M1. Further, the centers of the photodiodes are oriented to the centers of the pixels to arrange the centers of the pixels at regular optical intervals.

As described above, according to Embodiment 2 of the present invention, the FD wiring 9 is defined to be the second metal wiring M2 as shown in FIG. 8 instead of the first metal wiring M1. Although the effect of reducing the capacity C related to the floating diffusion FD is even smaller compared with the case of Embodiment 1, the floating diffusion FD and the reset diffusing region are formed in series with the two pixel sharing structure, and the drawn wiring between the floating diffusion FD and the gate 61 of the amplifying transistor 6 becomes a substantially straight line with the shortest length by the second layer metal wiring (FD wiring 9). As a result, it is possible to significantly reduce the capacity C regarding the floating diffusion FD, such as FD capacity C_{FD} and wiring capacity Cd due to the FD drawn wiring and it is possible to significantly improve the voltage conversion gain η. As a result, a solid-state image capturing device having high sensitivity and high resolution can be obtained. In addition, the centers of the photodiodes are oriented to the centers of the pixels, and the centers of the pixel are arranged optically at regular intervals. As a result, it is possible to prevent shading due to oblique incident light.

### Embodiment 3

According to Embodiment 1 described above, the active region area of the floating diffusion FD is reduced by half with the two pixel sharing structure, and the FD active region area is reduced by the reset transistor active region functioning as the active region of the floating diffusion FD. Further, in order to reduce the wiring capacity, the FD wiring 9, which extends from the floating diffusion FD to the gate of the amplifying transistor, is defined as the first metal wiring M1 instead of the second metal wiring M2. Further, the FD wiring has a layout in a substantially straight line with the shortest length. The centers of the photodiodes are oriented to the centers of the pixels to arrange the centers of the pixels in regular optical intervals. In Embodiment 3 of the present invention, the condition where the FD wiring 9, which extends from the floating diffusion FD to the gate of the amplifying transistor, is defined as the first metal wiring M1 instead of the second metal wiring M2 in order to reduce the wiring capacity, and the condition where the FD wiring 9 has a layout in a straight line with the shortest length are excluded from all the conditions in Embodiment 1.

According to the solid-state image capturing device having a two pixel sharing structure according to Embodiment 3 of the present invention, two photodiodes 12 and 13, which perform photoelectric conversion on an image light from a subject to capture the image of the subject, share one signal readout circuit 11. A signal charge is read out from the two photodiodes 12 and 13 to the common floating diffusion FD and the signal charge is converted into voltage. In accordance with the converted voltage, the signal readout is performed by the signal readout circuit 11. The FD wiring 9 extending from the floating diffusion FD to the gate 61 functioning as a control electrode of the amplifying transistor 6 of the signal readout circuit 11 is defined as the first layer of the metal wiring. Further, the centers of the photodiodes are oriented to the centers of the pixels to arrange the centers of the pixels at regular optical intervals.

As described above, according to Embodiment 3 of the present invention, the active region area of the floating diffusion FD is reduced by half with the two pixel sharing structure, and in order to reduce the wiring capacity, the FD wiring 9, which extends from the floating diffusion FD to the gate 61 of the amplifying transistor 6, is defined as the first metal wiring M1 instead of the second metal wiring M2. Further, the centers of the photodiodes are oriented to the centers of the pixels to arrange the centers of the pixels at regular optical intervals. Although the effect of reducing the capacity C regarding the floating diffusion FD is even smaller compared with the case of Embodiment 2, the drawn wiring between the floating diffusion FD and the gate 61 of the amplifying transistor 6 is formed with the second layer of the second metal wiring M2 and with the two pixel sharing structure. As a result, it is possible to significantly reduce the capacity C regarding the floating diffusion FD, such as FD capacity C_{FD} and wiring capacity Cd due to the FD drawn wiring and it is possible to significantly improve the voltage conversion gain η. As a result, a solid-state image capturing device having high sensitivity and high resolution can be obtained. In addition, the centers of the photodiodes are oriented to the centers of the pixels, and the centers of the pixel are arranged optically at regular intervals. As a result, it is possible to prevent shading due to oblique incident light.

### Embodiment 4

In Embodiment 4 of the present invention, an electronic information device will be described hereinafter. The electronic information device, such as a digital camera (e.g., digital video camera and digital still camera), an image input camera (e.g., monitoring camera, a door intercom camera, a car-mounted camera, a camera for television telephone and a camera for cell phone), a scanner, a facsimile machine and a camera-equipped cell phone device, has an image capturing section equipped with at least any of the solid-state image capturing devices according to Embodiments 1 to 3 of the present invention described above as an image input device.

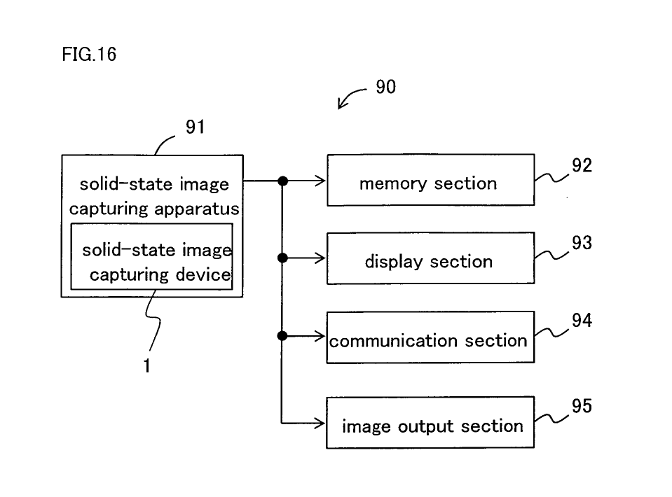

FIG. 16 is a block diagram showing an exemplary schematic structure of an electronic information device using a solid-state image capturing apparatus that includes any one of the solid-state image capturing devices according to Embodiments 1 to 3 of the present invention in an image capturing section, the electronic information device being described as Embodiment 4 of the present invention.

In FIG. 16, the electronic information device 90 according to Embodiment 4 of the present invention includes: a solid-state image capturing apparatus 91 for performing various kinds of signal processing on an image capturing signal from any one of the solid-state image capturing devices 1 according to Embodiments 1 to 3 described above to obtain a color image signal; a memory section 92 (e.g., recording media) for data-recording a high-quality color image data from the solid-state image capturing apparatus 91 after a predetermined signal process is performed on the image data for recording; a display section 93 (e.g., liquid crystal display device) for displaying the high-quality color image data from the solid-state image capturing apparatus 91 on a display screen (e.g., liquid crystal display screen) after a predetermined signal process is performed on the image data for display; a communication section 94 (e.g., transmitting and receiving device) for communicating the high-quality color image data from the solid-state image capturing apparatus 91 after a predetermined signal process is performed on the image data for communication; and an image output section 95 for printing (typing out) and outputting (printing out) the high-quality color image data from the solid-state image capturing apparatus 91. Besides, the electronic information device 90 may include, other than the solid-state image capturing apparatus 91, at least any one of the memory section 92, the display section 93, the communication section 94, and the image output section 95 such as a printer.

Therefore, according to Embodiment 4 of the present invention, the color image signal from the solid-state image capturing apparatus 91 can be: displayed on a display screen finely, printed out (printing) on a sheet of paper using the image output apparatus 95, communicated finely as communication data via a wire or a radio; stored finely at the memory section 92 by performing a predetermined data compression process; and various data processes can be finely performed.

Although not specifically described in Embodiments 1 to 4 described above, of the plurality of photodiodes for performing photoelectric conversion on image light from a subject to capture an image of the subject, every two photodiodes 12 and 13 share a signal readout circuit 11 in order to further reduce the floating diffusion capacity, a signal charge is read out from the two photodiodes 12 and 13 to a common floating diffusion FD to convert the signal charge into voltage, and a signal is read out to the signal line 7 by the signal readout circuit 11 in response to the converted signal voltage. With this structure, the photodiode area is secured even if the pixel area including the photodiode area and the transistor arrangement area is miniaturized. Further, the FD capacity is improved, and as a result, it is possible to achieve the objective to obtain a solid-state image capturing device having high sensitivity and high resolution and preventing shading due to an oblique incident light.

According to Embodiments 1 to 4 described above, one driving region on a signal output side of the amplifying transistor 6 is provided in a region between a lower right corner of the lower photodiode 13 of the two photodiodes 12 and 13, and an upper right corner of the upper photodiode 12 of another pair of two adjacent photodiodes 12 and 13 in a longitudinal downward direction. However, the present invention is not restricted to this structure. One driving region on a signal output side of the amplifying transistor 6 may be provided in a region between a upper right corner of the upper photodiode 12 of the two photodiodes 12 and 13, and an lower right corner of the lower photodiode 13 of another pair of two adjacent photodiodes 12 and 13 in a longitudinal upward direction. In this case, the signal line 7 is connected to one driving region on the signal output side of the amplifying transistor 6 through the contact C1, and the signal line 7 is arranged along the edge on the right side in a longitudinal direction of a plane rectangle or square of the two photodiodes 12 and 13.

Further, according to Embodiments 1 to 4 described above, the gate 61 on the signal output side of the amplifying transistor 6 is provided in a region between a corner of a pair of adjacent photodiodes 12 and 13 in a transverse direction to an lower right corner of a lower photodiode 13 of two different photodiodes 12 and 13, and a corner of an upper photodiode 12 of still another pair of adjacent photodiodes 12 and 13 in a longitudinal downward direction. However, the present invention is not restricted to this structure. The gate 61 of the amplifying transistor 6 may be provided in a region between a corner of a pair of adjacent photodiodes 12 and 13 in a transverse direction to an upper right corner of an upper photodiode 12 of a different pair of photodiodes 12 and 13, and a corner of a lower photodiode 13 of a still another pair of adjacent photodiodes 12 and 13 in a longitudinal upward direction. In this case, the FD wiring 9 extending from the floating diffusion FD to the gate 61 of the amplifying transistor 6 in the signal readout circuit 11 is connected to the gate 61 of the amplifying transistor 6 and the floating diffusion FD through respective contacts G1, and the FD wiring 9 is arranged along the edge in a longitudinal direction of a rectangle or square of the two photodiodes 12 and 13 in a plan view.

As described above, the present invention is exemplified by the use of its preferred Embodiments 1 to 4. However, the present invention should not be interpreted solely based on Embodiments 1 to 4 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 4 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a solid-state image capturing device having a multiple pixel sharing structure formed of semiconductor devices for performing photoelectric conversion on image light from a subject to capture an image of the subject; and an electronic information device, such as a digital camera (e.g., digital video camera and digital still camera), an image input camera, a scanner, a facsimile machine and a camera-equipped cell phone device, having the solid-state image capturing device having a multiple pixel sharing structure as an image input device in an image capturing section of the electronic information device. The present invention makes it possible to prevent shading due to oblique incident light by orienting the centers of the photodiodes to the centers of the pixels and arranging the centers of the pixel optically at regular intervals. In this state, the floating diffusion FD and the reset diffusing region are combined together to be shared in a two pixel sharing structure, and further, the drawn wiring between the floating diffusion FD and the gate of the amplifying transistor is connected by the first metal wiring M1 in the first layer (or the second metal wiring M2 in the second layer) to have a shortest layout. As a result, it is possible to significantly reduce the capacity C regarding the floating diffusion FD, such as FD capacity C_{FD} and wiring capacity Cd due to the FD drawn wiring. Further, voltage conversion gain η is significantly improved, and it is possible to provide higher sensitivity and higher resolution for the solid-state image capturing device.

In addition, the active region area of the floating diffusion FD can be reduced by half with the two pixel sharing structure, the first metal wiring M1 is defined as the FD wiring from the floating diffusion FD to the control electrode of the signal amplifying section so as to reduce the wiring capacity, and the centers of the photodiodes are oriented to the centers of the pixels to arrange the centers of the pixel optically at regular intervals. Although the effect of reducing the capacity C regarding the floating diffusion FD is even smaller, it is possible to significantly reduce the capacity C regarding the floating diffusion FD, such as FD capacity C_{FD} in the two pixel sharing structure and wiring capacity Cd due to the FD drawn wiring and it is possible to improve the voltage conversion gain η. As a result, it is possible to provide the solid-state image capturing device with a fine sensitivity and a fine resolution. In addition, S/N can be improved.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image capturing device having a two pixel sharing structure, in which every two light receiving sections share a signal readout circuit among a plurality of light receiving sections for performing photoelectric conversion on image light from a subject to capture an image of the subject, and a signal charge is read out from the two light receiving sections to a shared floating diffusion to convert the signal charge into voltage and a signal is read out by the signal readout circuit in accordance with the converted voltage,
wherein a reset section for resetting electric potential of the floating diffusion to a predetermined electric potential and a signal amplifying section for amplifying a signal in accordance with voltage of the floating diffusion to read out the signal are separately arranged, the reset section and signal amplifying section constituting the signal readout circuit,
wherein an active region of the reset section is configured to function as an active region of the floating diffusion,
wherein a wiring extending from the floating diffusion to a control electrode of the signal amplifying section is formed to be a first layer of a metal wiring having a layout of a straight line with a shortest length, and
wherein centers of the light receiving sections are oriented to centers of pixels and the centers of the pixels are arranged at regular optical intervals.

2. A solid-state image capturing device having a two pixel sharing structure, in which every two light receiving sections share a signal readout circuit among a plurality of light receiving sections for performing photoelectric conversion on image light from a subject to capture an image of the subject, and a signal charge is read out from the two light receiving sections to a shared floating diffusion to convert the signal charge into voltage and a signal is read out by the signal readout circuit in accordance with the converted voltage,
wherein a reset section for resetting electric potential of the floating diffusion to a predetermined electric potential and a signal amplifying section for amplifying a signal in accordance with voltage of the floating diffusion to read out the signal are separately arranged, the reset section and signal amplifying section constituting the signal readout circuit,
wherein one side of an active region of the reset section is configured to function as an active region of the floating diffusion,
wherein a wiring extending from the floating diffusion to a control electrode of the signal amplifying section is formed to be a layout of a straight line with a shortest length, and
wherein centers of the light receiving sections are oriented to centers of pixels and the centers of the pixels are arranged at regular optical intervals.

3. A solid-state image capturing device having a two pixel sharing structure, in which every two light receiving sections share a signal readout circuit among a plurality of light receiving sections for performing photoelectric conversion on image light from a subject to capture an image of the subject, and a signal charge is read out from the two light receiving sections to a shared floating diffusion to convert the signal charge into voltage and a signal is read out by the signal readout circuit in accordance with the converted voltage,
wherein a wiring extending from the floating diffusion to a control electrode of the signal amplifying section is formed to be a first layer of a metal wiring, and
wherein centers of the light receiving sections are oriented to centers of pixels and the centers of the pixels are arranged at regular optical intervals.

4. A solid-state image capturing device, in which every two light receiving sections share a signal readout circuit among a plurality of light receiving sections for performing photoelectric conversion on image light from a subject to capture an image of the subject in order to reduce a floating diffusion capacity, and a signal charge is read out from the two light receiving sections to a shared floating diffusion to convert the signal charge into voltage and a signal is read out by the signal readout circuit in accordance with the converted voltage,
wherein centers of the light receiving sections are oriented to centers of pixels and the centers of the pixels are arranged at regular optical intervals.

5. A solid-state image capturing device according to claim 1, wherein the floating diffusion is provided at either end portion side of a space between opposing edges of the two light receiving sections.

6. A solid-state image capturing device according to claim 2, wherein the floating diffusion is provided at either end portion side of a space between opposing edges of the two light receiving sections.

7. A solid-state image capturing device according to claim 3, wherein the floating diffusion is provided at either end portion side of a space between opposing edges of the two light receiving sections.

8. A solid-state image capturing device according to claim 4, wherein the floating diffusion is provided at either end portion side of a space between opposing edges of the two light receiving sections.

9. A solid-state image capturing device according to claim 5, wherein an electric charge transfer section is provided between the floating diffusion and the two light receiving sections and a control electrode of the electric charge transfer section is formed in a substantially triangular shape in a plan view covering one of four corner portions of the light receiving sections having a rectangular or square shape in a plan view.

10. A solid-state image capturing device according to claim 6, wherein an electric charge transfer section is provided between the floating diffusion and the two light receiving sections and a control electrode of the electric charge transfer section is formed in a substantially triangular shape in a plan view covering one of four corner portions of the light receiving sections having a rectangular or square shape in a plan view.

11. A solid-state image capturing device according to claim 7, wherein an electric charge transfer section is provided between the floating diffusion and the two light receiving sections and a control electrode of the electric charge transfer section is formed in a substantially triangular shape in a plan view covering one of four corner portions of the light receiving sections having a rectangular or square shape in a plan view.

12. A solid-state image capturing device according to claim 8, wherein an electric charge transfer section is provided between the floating diffusion and the two light receiving sections and a control electrode of the electric charge transfer section is formed in a substantially triangular shape in a plan view covering one of four corner portions of the light receiving sections having a rectangular or square shape in a plan view.

13. A solid-state image capturing device according to claim 9, wherein the control electrode of the electric charge transfer section and the reset section are provided in one direction along a belt shape longitudinal direction having a width of a space between the two light receiving sections in order to narrow the space.

14. A solid-state image capturing device according to claim 10, wherein the control electrode of the electric charge transfer section and the reset section are provided in one direction along a belt shape longitudinal direction having a width of a space between the two light receiving sections in order to narrow the space.

15. A solid-state image capturing device according to claim 11, wherein the control electrode of the electric charge transfer section and the reset section are provided in one direction along a belt shape longitudinal direction having a width of a space between the two light receiving sections in order to narrow the space.

16. A solid-state image capturing device according to claim 12, wherein the control electrode of the electric charge transfer section and the reset section are provided in one direction along a belt shape longitudinal direction having a width of a space between the two light receiving sections in order to narrow the space.

17. A solid-state image capturing device according to claim 1, wherein the floating diffusion is provided in between opposing corner portions of the two light receiving sections having a rectangular or square shape in a plan view, an electric charge transfer section is provided in between the floating diffusion and the two light receiving sections, and an active region of the electric charge transfer section is provided to function as an active region of the floating diffusion.

18. A solid-state image capturing device according to claim 2, wherein the floating diffusion is provided in between opposing corner portions of the two light receiving sections having a rectangular or square shape in a plan view, an electric charge transfer section is provided in between the floating diffusion and the two light receiving sections, and an active region of the electric charge transfer section is provided to function as an active region of the floating diffusion.

19. A solid-state image capturing device according to claim 3, wherein the floating diffusion is provided in between opposing corner portions of the two light receiving sections having a rectangular or square shape in a plan view, an electric charge transfer section is provided in between the floating diffusion and the two light receiving sections, and an active region of the electric charge transfer section is provided to function as an active region of the floating diffusion.

20. A solid-state image capturing device according to claim 4, wherein the floating diffusion is provided in between opposing corner portions of the two light receiving sections having a rectangular or square shape in a plan view, an electric charge transfer section is provided in between the floating diffusion and the two light receiving sections, and an active region of the electric charge transfer section is provided to function as an active region of the floating diffusion.

21. A solid-state image capturing device according to claim 1, wherein, among the plurality of light receiving sections provided in a matrix in longitudinal and transverse directions, the two light receiving sections are provided adjacent to each other in a column direction in a plan view to form a unit pixel section.

22. A solid-state image capturing device according to claim 2, wherein, among the plurality of light receiving sections provided in a matrix in longitudinal and transverse directions, the two light receiving sections are provided adjacent to each other in a column direction in a plan view to form a unit pixel section.

23. A solid-state image capturing device according to claim 3, wherein, among the plurality of light receiving sections provided in a matrix in longitudinal and transverse directions, the two light receiving sections are provided adjacent to each other in a column direction in a plan view to form a unit pixel section.

24. A solid-state image capturing device according to claim 4, wherein, among the plurality of light receiving sections provided in a matrix in longitudinal and transverse directions, the two light receiving sections are provided adjacent to each other in a column direction in a plan view to form a unit pixel section.

25. A solid-state image capturing device according to claim 21, a signal amplifying section configuring the signal readout circuit is provided between rows of the unit pixel sections.

26. A solid-state image capturing device according to claim 22, a signal amplifying section configuring the signal readout circuit is provided between rows of the unit pixel sections.

27. A solid-state image capturing device according to claim 23, a signal amplifying section configuring the signal readout circuit is provided between rows of the unit pixel sections.

28. A solid-state image capturing device according to claim 24, a signal amplifying section configuring the signal readout circuit is provided between rows of the unit pixel sections.

29. A solid-state image capturing device according to claim 25, wherein the signal amplifying section is configured with an amplifying transistor, and one driving region on a signal output side of the amplifying transistor is provided in a region between a corner portion on the row side of the two light receiving sections and a corner portion of another adjacent pair of two light receiving sections in either one or the other direction in a longitudinal direction.

30. A solid-state image capturing device according to claim 26, wherein the signal amplifying section is configured with an amplifying transistor, and one driving region on a signal output side of the amplifying transistor is provided in a region between a corner portion on the row side of the two light receiving sections and a corner portion of another adjacent pair of two light receiving sections in either one or the other direction in a longitudinal direction.

31. A solid-state image capturing device according to claim 27, wherein the signal amplifying section is configured with an amplifying transistor, and one driving region on a signal output side of the amplifying transistor is provided in a region between a corner portion on the row side of the two light receiving sections and a corner portion of another adjacent pair of two light receiving sections in either one or the other direction in a longitudinal direction.

32. A solid-state image capturing device according to claim 28, wherein the signal amplifying section is configured with an amplifying transistor, and one driving region on a signal output side of the amplifying transistor is provided in a region between a corner portion on the row side of the two light receiving sections and a corner portion of another adjacent pair of two light receiving sections in either one or the other direction in a longitudinal direction.

33. A solid-state image capturing device according to claim 25, wherein a gate on a signal output side of the amplifying transistor is provided in a row region including a space between a corner portion of another adjacent pair of two light receiving sections in a transverse direction to the corner portion on the row side of the two different light receiving sections, and a corner portion of still another adjacent pair of light receiving sections in either one or the other direction in a longitudinal direction.

34. A solid-state image capturing device according to claim 26, wherein a gate on a signal output side of the amplifying transistor is provided in a row region including a space between a corner portion of another adjacent pair of two light receiving sections in a transverse direction to the corner portion on the row side of the two different light receiving sections, and a corner portion of still another adjacent pair of light receiving sections in either one or the other direction in a longitudinal direction.

35. A solid-state image capturing device according to claim 27, wherein a gate on a signal output side of the amplifying transistor is provided in a row region including a space between a corner portion of another adjacent pair of two light receiving sections in a transverse direction to the corner portion on the row side of the two different light receiving sections, and a corner portion of still another adjacent pair of light receiving sections in either one or the other direction in a longitudinal direction.

36. A solid-state image capturing device according to claim 28, wherein a gate on a signal output side of the amplifying transistor is provided in a row region including a space between a corner portion of another adjacent pair of two light receiving sections in a transverse direction to the corner portion on the row side of the two different light receiving sections, and a corner portion of still another adjacent pair of light receiving sections in either one or the other direction in a longitudinal direction.

37. A solid-state image capturing device according to claim 29, wherein a signal line is connected to one driving region on a signal output side of the amplifying transistor through a contact, and the signal line is arranged in a substantially straight line along a longitudinal edge of the light receiving sections having a rectangular or square shape in a plan view.

38. A solid-state image capturing device according to claim 30, wherein a signal line is connected to one driving region on a signal output side of the amplifying transistor through a contact, and the signal line is arranged in a substantially straight line along a longitudinal edge of the light receiving sections having a rectangular or square shape in a plan view.

39. A solid-state image capturing device according to claim 31, wherein a signal line is connected to one driving region on a signal output side of the amplifying transistor through a contact, and the signal line is arranged in a substantially straight line along a longitudinal edge of the light receiving sections having a rectangular or square shape in a plan view.

40. A solid-state image capturing device according to claim 32, wherein a signal line is connected to one driving region on a signal output side of the amplifying transistor through a contact, and the signal line is arranged in a substantially straight line along a longitudinal edge of the light receiving sections having a rectangular or square shape in a plan view.

41. A solid-state image capturing device according to claim 33, wherein a wiring extending from the floating diffusion to the control electrode of the signal amplifying section in the signal readout circuit is connected to the gate on the signal output side of the amplifying transistor and the floating diffusion through respective contacts, and the wiring is arranged in a substantially straight line along a longitudinal edge of another adjacent pair of two light receiving sections having a rectangular or square shape in a plan view in a transverse direction to the different two light receiving sections.

42. A solid-state image capturing device according to claim 34, wherein a wiring extending from the floating diffusion to the control electrode of the signal amplifying section in the signal readout circuit is connected to the gate on the signal output side of the amplifying transistor and the floating diffusion through respective contacts, and the wiring is arranged in a substantially straight line along a longitudinal edge of another adjacent pair of two light receiving sections having a rectangular or square shape in a plan view in a transverse direction to the different two light receiving sections.

43. A solid-state image capturing device according to claim 35, wherein a wiring extending from the floating diffusion to the control electrode of the signal amplifying section in the signal readout circuit is connected to the gate on the signal output side of the amplifying transistor and the floating diffusion through respective contacts, and the wiring is arranged in a substantially straight line along a longitudinal edge of another adjacent pair of two light receiving sections having a rectangular or square shape in a plan view in a transverse direction to the different two light receiving sections.

44. A solid-state image capturing device according to claim 36, wherein a wiring extending from the floating diffusion to the control electrode of the signal amplifying section in the signal readout circuit is connected to the gate on the signal output side of the amplifying transistor and the floating diffusion through respective contacts, and the wiring is arranged in a substantially straight line along a longitudinal edge of another adjacent pair of two light receiving sections having a rectangular or square shape in a plan view in a transverse direction to the different two light receiving sections.

45. A solid-state image capturing device according to claim 1, wherein the other active region of the reset section and one driving region of a pixel selection section are connected to each other by a power supply line of the first layer of the metal wiring through respective contacts, the other driving region of the pixel selection section being connected in series to the other driving region of the signal amplifying section.

46. A solid-state image capturing device according to claim 2, wherein the other active region of the reset section and one driving region of a pixel selection section are connected to each other by a power supply line of the first layer of the metal wiring through respective contacts, the other driving region of the pixel selection section being connected in series to the other driving region of the signal amplifying section.

47. A solid-state image capturing device according to claim 45,
wherein the two light receiving sections are arranged in a longitudinal direction, and
wherein every row in the plurality of light receiving sections provided in longitudinal and transverse directions on a display screen is successively selected by the pixel selection section and a signal is amplified by the signal amplifying section to read out the signal.

48. A solid-state image capturing device according to claim 46,
wherein the two light receiving sections are arranged in a longitudinal direction, and
wherein every row in the plurality of light receiving sections provided in longitudinal and transverse directions on a display screen is successively selected by the pixel selection section and a signal is amplified by the signal amplifying section to read out the signal.

49. A solid-state image capturing device according to claim 1, wherein the regular interval arrangement for the centers of the pixels includes an arrangement pitch for the centers of the pixels including the light receiving section and a transistor arrangement region, which is a part of the signal readout circuit, being equal in both a row direction and a column direction.

50. A solid-state image capturing device according to claim 2, wherein the regular interval arrangement for the centers of the pixels includes an arrangement pitch for the centers of the pixels including the light receiving section and a transistor arrangement region, which is a part of the signal readout circuit, being equal in both a row direction and a column direction.

51. A solid-state image capturing device according to claim 3, wherein the regular interval arrangement for the centers of the pixels includes an arrangement pitch for the centers of the pixels including the light receiving section and a transistor arrangement region, which is a part of the signal readout circuit, being equal in both a row direction and a column direction.

52. A solid-state image capturing device according to claim 4, wherein the regular interval arrangement for the centers of the pixels includes an arrangement pitch for the centers of the pixels including the light receiving section and a transistor arrangement region, which is a part of the signal readout circuit, being equal in both a row direction and a column direction.

53. A solid-state image capturing device according to claim 17, wherein the active region of the floating diffusion, the active region of the electric charge transfer section and the active region of the reset section are drawn close to one another and are shared so that a floating diffusion area becomes minimum on a layout.

54. A solid-state image capturing device according to claim 18, wherein the active region of the floating diffusion, the active region of the electric charge transfer section and the active region of the reset section are drawn close to one another and are shared so that a floating diffusion area becomes minimum on a layout.

55. A solid-state image capturing device according to claim 19, wherein the active region of the floating diffusion, the active region of the electric charge transfer section and the active region of the reset section are drawn close to one another and are shared so that a floating diffusion area becomes minimum on a layout.

56. A solid-state image capturing device according to claim 20, wherein the active region of the floating diffusion, the active region of the electric charge transfer section and the active region of the reset section are drawn close to one another and are shared so that a floating diffusion area becomes minimum on a layout.

57. A solid-state image capturing device according to claim 1, being a MOS solid-state image capturing device.

58. A solid-state image capturing device according to claim 2, being a MOS solid-state image capturing device.

59. A solid-state image capturing device according to claim 3, being a MOS solid-state image capturing device.

60. A solid-state image capturing device according to claim 4, being a MOS solid-state image capturing device.

61. An electronic information device using the solid-state image capturing device according to claim 1 as an image input device in an image capturing section.
